(19) United States
(12) Patent Application Publication
(10) Pub. No.: US 2018/0281506 A1
(43) Pub. Date: Oct. 4, 2018

(54) ADHESIVE BACKED DECORATIVE ARTICLE, METHOD OF MAKING, AND METHOD OF USE

(71) Applicant: 3M INNOVATIVE PROPERTIES COMPANY, St. Paul, MN (US)

(72) Inventor: Ken EGASHIRA, Chigasaki, Kanagawa (JP)

(21) Appl. No.: 15/766,125

(22) PCT Filed: Oct. 6, 2016
(86) PCT No.: PCT/US2016/055629

§ 371 Date: Apr. 5, 2018

(30) Foreign Application Priority Data
Oct. 9, 2015 (JP) 2015-200924

(51) Int. Cl. B44C 1/10; C09J 7/25; B60R 13/04

(52) U.S. Cl. CPC B44C 1/105; B60R 13/04; C09J 7/25

(57) ABSTRACT

A decorative article comprising a main body portion that can be deformed based on the shape of an adhering surface, and can be fixed to the adhering surface via an adhesive layer, without substantially stretching during adhesion. The main body portion will not inelastically deform, even if an operator pulls on the main body portion, when adhering to the adhering surface. The main body portion is deformed based on the shape of the adhering surface. Therefore, when the operator deforms the main body portion based on the shape of the adhering surface and adheres the adhesive-backed decorative article to the adhering surface, it is not necessary to perform a position adjustment by pulling and stretching the main body portion. Furthermore, an adhesive-backed decorative article can be adhered to the adhering surface regardless of the shape of the adhering surface.

### FIELD OF THE INVENTION

The present invention relates to an adhesive-backed decorative article, a method for manufacturing the adhesive-backed decorative article, and a method of use that includes adhering the adhesive-backed decorative article to an adhering surface of a substrate, such as a vehicle component.

### BACKGROUND

Various articles are proposed as a decorative article adhered on an adhering surface of a substrate. For example, in patent Japanese Unexamined Patent Application Publication (Translation of PCT Application) No. 2002-544364, an extensible film is disclosed as a decorative article that decorates (e.g., paints) a vehicle component, provided with a pressure-sensitive adhesive layer on its back face. This adhesive-backed decorative article is adhered on an adhering surface of a substrate via an adhesive while positioning the extensible film. Furthermore, in patent Japanese Unexamined Patent Application Publication No. 2010-111157, a garnish made of resin is disclosed that is adhered on a substrate such as a door frame for a vehicle. This garnish is adhered on the adhering surface of the door frame by joining means such as double-sided adhesive tape provided on an end portion.

### SUMMARY OF THE INVENTION

Because the extensible film disclosed in Japanese Unexamined Patent Application Publication (Translation of PCT Application) No. 2002-544364 is thin, easy to be wrinkled, and sags down by its own weight, when adhering to a substrate, it is necessary to position the end face of the film with respect to the adhering surface, and perform adhering while pulling and stretching the extensible film after partially securing it. Because of this, labor is required for the adhering operation. Furthermore, because the extensible film is thin and extensible, there are times when dirt or other unevenness on the adhering surface of the substrate (e.g., defects on the adhering surface of the substrate) are reflected on the surface of the film after adhering, which can cause problems in the appearance of the extensible film.

Meanwhile, because the garnish disclosed in Japanese Unexamined Patent Application Publication No. 2010-111157 is a rigid body and does not generally deform when adhering to a substrate, the adhering operation of an extensible film is simple, and fine unevenness on the adhering surface of the substrate does not affect the appearance after adhering. However, because these garnishes are generally formed by injection molding and the like, the manufacturing method takes work such as needing to prepare a mold based on the shape of each deposition face. Moreover, because garnishes are rigid bodies that have a certain thickness or more, they are heavy, and lighter bodies are sought after.

The adhesive-backed decorative article according to one embodiment of the present invention is such an article for adhering to an adhering surface of a substrate. The decorative article is provided with a main body portion having a front face to be a design face and a back face, an end portion extending from one side of the main body portion, having a front face forming a prescribed angle relative to the front face of the main body portion, and an adhesive portion disposed on at least one portion of the back face side of the main body portion. The main body portion is deformable based on the shape of the adhering surface, and it can also be adhered and secured to the adhering surface via the adhesive portion without substantially stretching it during adhering.

The manufacturing method of the adhesive-backed decorative article according to one embodiment of the present invention is a manufacturing method of such an article to adhere to the adhering surface of a substrate, and has a step for preparing a sheet-shaped member with an adhesive attached having a front face that will be a design face, and a bending step for bending an end portion of the sheet-shaped member and forming a fixed angle relative to a surface.

The adhering method of the adhesive-backed decorative article according to one embodiment of the present invention adheres an adhesive-backed decorative article to the adhering surface of a substrate, and includes a step for preparing an adhesive-backed decorative article, and a step for deforming the main body portion based on the shape of the adhering surface, and adhering and securing the main body portion to the adhering surface via the adhesive portion without substantially stretching.

According to one aspect of the present invention, an adhering can be easily performed by providing a favorable design face that is less susceptible to effects from roughness on the adhering surface, and handleability can be improved.

### BRIEF DESCRIPTION OF THE DRAWINGS

FIG. 1 is a front face view of the adhesive-backed decorative article according to the embodiment.

FIG. 2(a) is a cross-sectional diagram along the IIa-IIa line illustrated in FIG. 1. FIG. 2(b) is a cross-sectional diagram along the IIb-IIb line illustrated in FIG. 1.

FIG. 3 is a diagram illustrating a B pillar with the adhesive-backed decorative article adhered thereon according to the embodiment.

FIG. 4 is a schematic cross-sectional diagram along the IV-IV line illustrated in FIG. 3.

FIG. 5 is a schematic cross-sectional diagram illustrating a variation of the end portion.

FIG. 6 is a diagram for describing the adhering method for the adhesive-backed decorative article.

FIG. 7 is a diagram for describing the adhering method for the adhesive-backed decorative article.

FIG. 8 is a diagram showing the bending step for the end portion.

FIG. 9 is a diagram for describing the bending progress.

FIG. 10 is a diagram for describing the adhering method for the adhesive-backed decorative article.

### MODES FOR CARRYING OUT THE INVENTION

The adhesive-backed decorative article according to one embodiment of the present invention can decorate a substrate with a design face by providing a design face and adhering it to an adhering surface of various substrates. The type of substrate to be decorated is not limited; a vehicle component, an electrical component, a building component, and the like are typically given as representative.

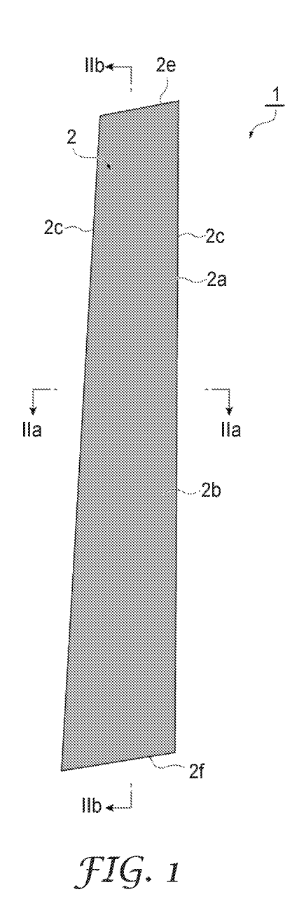

The adhesive-backed decorative article according to one embodiment of the present invention is provided with a main body portion having a front face to be a design face and a back face, an end portion extending from one side of the main body portion, having a front face forming a prescribed angle relative to the front face of the main body portion, and an adhesive portion disposed on at least one portion of the back face side of the main body portion. The main body portion is deformable based on the shape of the adhering surface, and it can also be adhered and secured to the adhering surface via the adhesive portion without substantially stretching it during adhering. A specific structure example will be described later, but the adhesive-backed decorative article of the present embodiment is represented by adhesive-backed decorative article 1 adhered to a door frame component or a window frame component that is a component for an automobile, as illustrated in FIGS. 1 to 3.

Note that in the present specification, “design face” refers to a face with various designs performed thereon to decorate a substrate. The design changes based on the intended use of the substrate with the adhesive-backed decorative article adhered thereon. A pattern made up of black, another single color, or clear, or alternatively, a plurality of hues, characters, illustrations or the like are given as typical designs. In addition to this, a fine, rough pattern may be performed on the front face, such as an embossment.

“deform based on the shape of the adhering surface” refers to deforming along the face following the curved face when the adhering surface is curved. The direction of the curve of the adhering surface is not limited, but, for example, a curved face with a radius of 500 mm to 2000 mm in the longitudinal direction is typically provided as an adhering surface of a substrate such as, for example, a vehicle door frame.

“Having a front face forming a prescribed angle relative to the front face of the main body portion” means that the end portion is slanted or curved with regards to the front face, typically between 0° and 180°, for example, 90°, relative to the front face of the main body portion as a reference. The shape of the angle is not limited to one location, and the angle may be changed in steps in a plurality of locations on the end portion. Incidentally, the shape of the angle is not limited to a straight line, and may be formed by a curved face shape.

“The main body portion can be adhered and secured to the adhering surface via the adhesive portion” is the state of being able to maintain a state wherein the main body portion remains secured to the adhering surface by the adhesive force of the adhesive layer after the main body unit is adhered to the adhering surface via the adhesive layer. For example, even if the bending rigidity of the main body portion is high, and it is forcibly secured to the adhering surface by an operator applying excessive pressure, because the restoring force of the main body portion is greater than the adhesive force of the adhesive layer, a state of the main body portion being peeled off from the adhering surface is not included in the state of being able to be “adhered and secured to the adhering surface via the adhesive portion”.

“Without substantially stretching during adhering” refers to the original length and width of the main body portion not changing by the general force applied to the adhesive-backed decorative article when an operator performs an adhering operation for the adhesive-backed decorative article. For example, at the very least, stretching does not occur due to elastic or inelastic deformations even if a force of 50 mN to 2.5 N is applied to the adhesive-backed decorative article during the adhering operation.

According to one aspect of the present invention, the main body portion is deformable based on the shape of the adhering surface, and it can also be adhered and secured to the adhering surface via the adhesive portion without substantially stretching. In other words, the main body portion has flexibility of a level to deform based on the shape of the adhering surface, and rigidity of a level to not stretch during adhering. By this rigidity, the adhesive-backed decorative article has autonomy, and because it does not easily stretch due to the general force of the operator during adhering, it is difficult for deformation, wrinkles, or the like to occur, and the adhering operation becomes simple. Furthermore, by this rigidity, the end portion can have a front face that maintains a fixed angle relative to the front face of the main body unit, and therefore, the operator can use the previously formed bent portion without needing to bend the end portion during adhering, thus making it easier to adjust the position. In addition, because the design of the adhesive-backed decorative article is less susceptible to effects of fine unevenness due to scratches or debris on the adhering surface, a design face with a favorable appearance without roughness can be given to the substrate. Furthermore, in this manner, the adhesive-backed decorative article that has both flexibility and rigidity is light compared to a conventional garnish, and can improve fuel consumption and lighten the burden on an operator from the load of the adhesive-backed decorative article. In addition, due to its flexibility, the molding method is not limited to injection molding, and a simpler molding method including a bending process can be selected.

In the present embodiment, the bending rigidity of the adhesive-backed decorative article may be 0.05 N to 2.5 N. In other words, the bending rigidity of the adhesive-backed decorative article may be 0.05 N or greater, 0.1 N or greater, or 0.2 N or greater. Furthermore, it may also be 2.5 N or less, 2 N or less, or 1.5 N or less. When it is 0.05 N or greater, the adhesive-backed decorative article can support itself during adhering of the adhesive-backed decorative article, and is less susceptible to sag down with its own weight, thereby making the operation simple. Meanwhile, if 2.5 N or less, the adhesive-backed decorative article is deformed simply following an adhering surface with a bent face, and the main body portion can be simply secured to the adhering surface via the adhesive portion.

In the present embodiment, tensile elongation strength of the adhesive-backed decorative article at 2% may be 40 N/10 mm or greater. Furthermore, the tensile elongation strength of the adhesive-backed decorative article at 2% may be 50 N/10 mm or greater, or 60 N/10 mm or greater. If 40 N/10 mm or greater, the adhesive-backed decorative article will not simply stretch by the force of the operator applied to the adhesive-backed decorative article while adhering of the adhesive-backed decorative article. Because of this, wrinkles and the like will not occur on the adhesive-backed decorative article during the operation, and the operation becomes simple.

In the present embodiment, the thickness of the main body portion of the adhesive-backed decorative article may be 0.2 to 1.2 mm. In other words, the thickness of the main body portion may be 0.2 mm or greater, 0.3 mm or greater, or 0.4 mm or greater. Furthermore, it may also be 1.2 mm or less, 1.0 mm or less, or 0.8 mm or less. By setting it to 0.2 mm or greater, a constant rigidity can be given to the adhesive-backed decorative article. Furthermore, by setting it to 1.2 mm or less, it becomes possible to make the adhesive-backed decorative article lighter.

In the present embodiment, a single layer or laminated body of various resins, such as, for example, polycarbonate resin, non-stretched polyethylene terephthalate (PET) resin, acrylonitrile-butadiene-styrene (ABS) resin, and rigid polyvinyl chloride (PVC) resin, can be used as the main body portion of the adhesive-backed decorative article, but it is particularly desirable to include a resin layer with a glass transition temperature of 130° C. or greater. With these resin layers, a main body portion can be formed having both appropriate flexibility and rigidity. When using a polycarbonate layer with resistance to heat, the bending process of the end portion becomes particularly simple at a temperature of 80° C. or greater.

In the present embodiment, the main body portion of the adhesive-backed decorative article may be provided with a front face protective layer. It is preferable to include a polyurethane layer as the front face protective layer. By this, damage to the design face is prevented, and weather resistance can be further improved. It is preferable for the front face protective layer to have a rupture elongation of 100% or greater at 80° C. or greater. By using this kind of material, the main body portion and the end portion use one sheet-shaped member with an adhesive portion attached, and it becomes possible to bend and form the end portion while heating the end portion of the sheet-shaped member.

In the present embodiment, the adhesive portion may be laminated on the entire back face of the main body portion. By forming the adhesive portion on the entire back face of the main body portion, the main body portion can be uniformly and surely secured to the adhering surface. Note that the adhesive portion may have a microstructure. For example, unevenness of the adhesive portion formed by a microstructure improves the slidability of the adhesive-backed decorative article with respect to the adhering surface of the adhesive-backed decorative article while adhering, and adhering becomes simpler.

In the present embodiment, the end portion may have a shape covering at least a portion of the side face of one end edge along one end edge of the adhering surface when adhering to the adhering surface. By applying such a shape, the appearance can be made favorable. In this case, the end portion may have a surface forming an angle of approximately 90° relative to the front face of the main body. Furthermore, the end portion may be able to change the angle in steps, and have a second end portion that extends from a second side that opposes one side, having a surface forming a fixed angle relative to the front face of the main body. There may also be a third end portion connected to a second end portion, having an angle different from the second end portion. Furthermore, the third end portion may have an angle of approximately 0° relative to the front face of the main body portion, or in other words, the third end portion may be a surface parallel with the front face of the main body portion.

In the present embodiment, surface roughness of the front face which is a design face of the adhesive-backed decorative article can be made substantially the same before and after adhering the adhesive-backed decorative article to the adhering surface of the substrate. That is to say, the adhesive-backed decorative article of the present embodiment is less susceptible to effects from fine unevenness due to the existence of scratches or debris on the adhering surface of the substrate because it has rigidity above a certain amount, and regardless of this unevenness, the roughness can be maintained in a substantially uniform manner.

In the present embodiment, it is possible to manufacture with a step for preparing a sheet-shaped member with an adhesive attached having a front face that will be a design face, and a bending step for bending an end portion of the sheet-shaped member and forming a fixed angle relative to a surface. For example, the bending step can have a step for preparing a pair of molds, a step for securing the sheet-shaped member to one of the molds, and a step for forming a fixed angle relative to the sheet-shaped member by relatively moving at least one of the one mold or the other mold. Because the adhesive-backed decorative article of the present embodiment is provided with flexibility and rigidity, it is possible to mold the end portion in this kind of simple bending step without a process such as injection molding as with a conventional garnish. Note that by heating to 80° C. or greater during the bending step, it is possible to more simply perform the bending step.

An embodiment of the present invention is described in detail below while referencing the accompanying drawings. In the explanations of the drawings, identical or equivalent elements are labeled with the same symbols, and redundant explanations will be omitted.

The adhesive-backed decorative article according to an embodiment of the present invention is adhered to the adhering surface of a substrate. The adhesive-backed decorative article forms a design face on the adhering surface side of the substrate to which it is adhered. Any substrate can be applied as the substrate to which the adhesive-backed decorative article is to be adhered as long as it is necessary to form a design face. For example, the adhesive-backed decorative article may be adhered to an automobile component or the like as the substrate. Furthermore, the adhesive-backed decorative article may be adhered to a door frame component for a vehicle as the substrate. For example, an A pillar (front side pillar), a C pillar (back side pillar) or the like of an automobile are given as door frame components for a vehicle. Moreover, the adhesive-backed decorative article may be adhered to a window frame component for a vehicle as the substrate. A B pillar (central pillar in the front-back direction of the vehicle) or the like is given as a window frame component of a vehicle.

### Configuratioin of the Adhesive-Backed Decorative Article

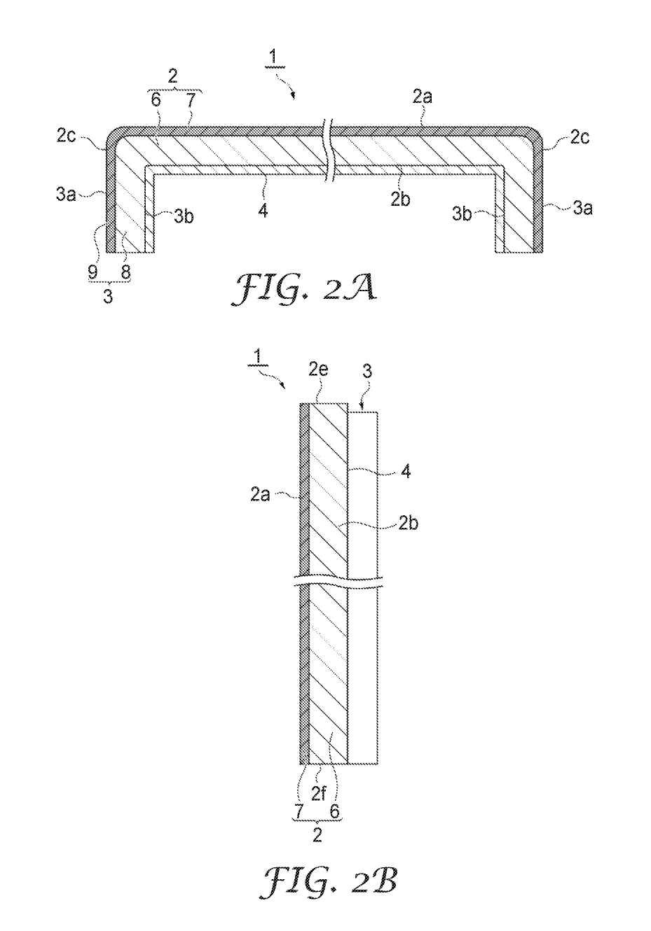

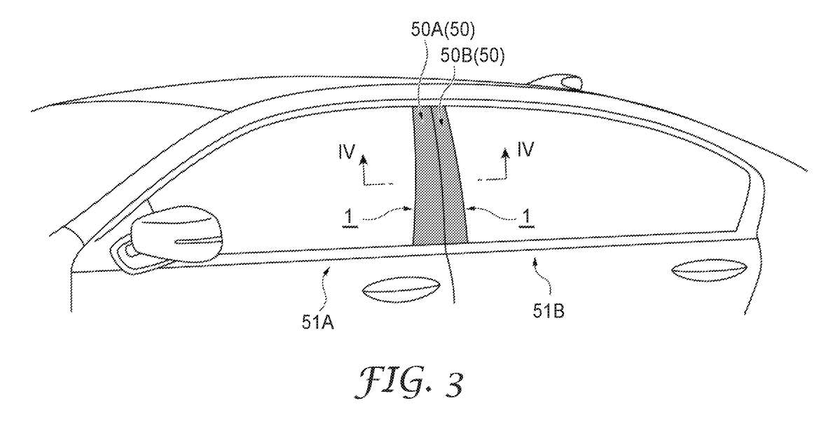

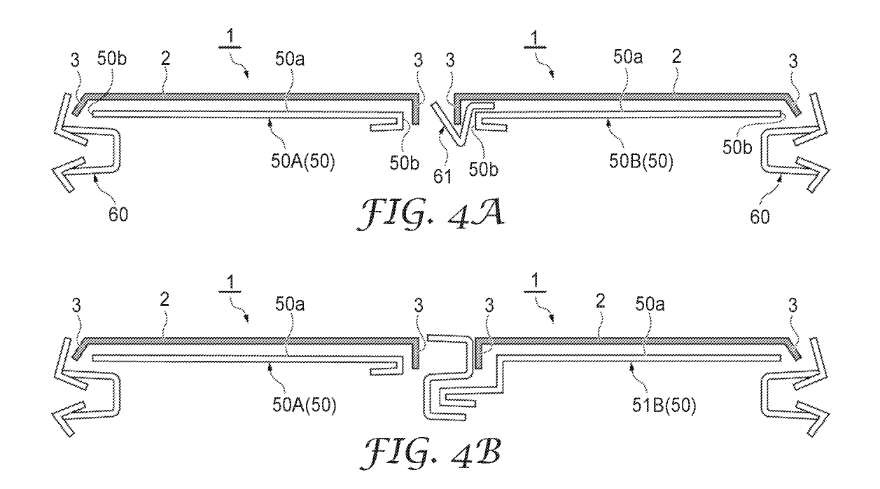

In the embodiment illustrated in FIGS. 1 to 4, a description is given as an example where the adhesive-backed decorative article is a cover member adhered to a B pillar 50 as the door frame component of an automobile. The B pillar 50 is provided with a B pillar 50A provided on a front side door 51A and a B pillar 50B provided on a back side door 51B (see FIG. 3). The face of the B pillar 50 on the vehicle exterior side is formed as an adhering surface 50a (see FIG. 4). The adhering surface 50a extends in the vertical direction and is slightly curved to stick out toward the vehicle exterior side. As illustrated in FIG. 1 and FIG. 2, an adhesive-backed decorative article 1 is provided with a main body portion 2, an end portion 3, and an adhesive layer (adhesive portion) 4.

The main body portion 2 has a front face 2a that will become the design face and a back face 2b. The main body portion 2 has a shape covering at least one portion of the adhering surface 50a of the B pillar of the vehicle in a planar view. In the present embodiment, the main body portion 2 has a shape covering almost the entirety of the adhering surface 50a of the B pillar. Specifically, the main body portion 2 extends along a first direction (vertical direction of the paper illustrated in FIG. 1), and has a belt shape. The main body portion 2 has a pair of sides 2c and 2c that extend in the longitudinal direction (first direction) and oppose each other. Furthermore, the main body portion 2 has a pair of sides 2e and 2f that extend in the short direction and oppose each other. The pair of sides 2c and 2c of the main body portion 2 extend slanting so that the distance between them increases moving toward the bottom end side 2f from the upper end side 2e. However, the shape of the main body portion 2 may be appropriately changed according to the shape of the adhering surface 50a.

The end portion 3 extends from at least one side of the main body portion 2, and has a front face 3a forming a fixed angle relative to a front face 2a of the main body portion 2. In the present embodiment, the end portion 3 extends from each of the sides 2c and 2c of the main body portion 2. End portions 3 each extend from the sides 2c and 2c of the main body portion 2 to head towards a back face 2b side from the front face 2a side of the main body portion 2. Note that one of the sides 2c corresponds to “one side” in the claims, and the other side 2c corresponds to “second side” in the claims, but it is not particularly limited as to which is the “one side” and which is the “second side”. That is to say, one of the end portions 3 corresponds to “end portion” in the claims, and the other end portion 3 corresponds to “second end portion” in the claims, but it is not particularly limited as to which is the “end portion” and which is the “second end portion”. In the present embodiment, the end portions 3 make an approximately 90° angle with the main body portion 2. Therefore, the end portion 3 has the front face 3a forming an angle of approximately 90° relative to the front face of the main body portion 2. However, the angle the end portions 3 make with the main body portion 2 is not particularly limited, and the angle the front face 3a of the end portions 3 makes with the front face 2a of the main body portion 2 is not limited as well. The end portions 3 have the front face 3a on the outer periphery side of the main body portion 2, and have a back face 3b on the inner periphery side of the main body portion 2. The end portions 3 have a shape covering at least one portion of a side face 50b of one end edge along the one end edge of the adhering surface 50a (see FIG. 4) when the main body portion 2 is adhered to the adhering surface 50a of the B pillar 50. One end edge of the adhering surface 50a and the side face 50b extend along the longitudinal direction of the B pillar 50B. In the present embodiment, the end portions 3 are formed along almost the entire region of the sides 2c of the main body 2, but, for example, the end portions 3 may not be formed on a portion near the upper end and the lower end. Furthermore, the amount that protrudes from the main body portion 2 of the end portions 3 is not particularly limited as long as it doesn't interfere with other substrates (e.g., vehicle components). For example, the amount that protrudes from the main body portion 2 of the end portion 3 may be smaller than the thickness of the B pillar 50, or may be the same amount.

For example, as illustrated in FIG. 4(a), the vicinity of the back end of the B pillar 50B (vicinity of the end portion on the right side of the sheet) is protected by the end portion 3 of the adhesive-backed decorative article 1 and a portion of a weather strip 60 received while sealing glass. The vicinity of the front end of the B pillar 50B (vicinity of the end portion on the left side of the sheet) is protected by the end portion 3 of the adhesive-backed decorative article 1 and a portion of a parting seal 61 sealing the gap of the door. The vicinity of the front end of the B pillar 50A is protected by the end portion 3 of the adhesive-backed decorative article 1 and a portion of the weather strip 60 received while sealing glass. The vicinity of the back end of the B pillar 50A is protected by the end portion 3 of the adhesive-backed decorative article 1. Note that as illustrated in FIG. 4(b), the shape of the parting seal 61 may be changed based on the shape of the front end of the B pillar 50B.

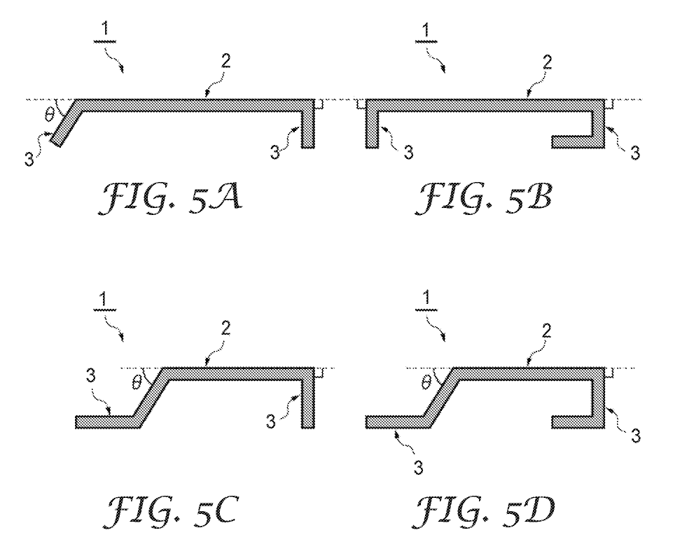

Moreover, the shape of the end portions 3 of the adhesive-backed decorative article 1 may be appropriately changed based on the shape of the end portion of the B pillar. For example, as illustrated in FIG. 5(a), one of the end portions 3 of the adhesive-backed decorative article 1 may not be at approximately 90° with the main body portion 2, but may be slanted at a prescribed angle (θ). As illustrated in FIG. 5(b), one of the end portions 3 of the adhesive-backed decorative article 1 may form an approximately 90° angle with the main body portion 2, and may extend in parallel with the main body portion 2 further toward the inner side at the tip end portion. As illustrated in FIG. 5(c), one of the end portions 3 of the adhesive-backed decorative article 1 may be slanted at a prescribed angle (θ) with the main body portion 2, and may extend in parallel with the main body portion 2 further toward the outer side at the tip end portion. As illustrated in FIG. 5(d), one of the end portions 3 of the adhesive-backed decorative article 1 may slant at a prescribed angle with the main body portion 2, and may extend in parallel with the main body portion 2 further toward the outer side at the tip end portion, and the other of the end portions 3 of the adhesive-backed decorative article 1 may slant at an angle of approximately 90° with the main body portion 2, and may extend in parallel with the main body portion 2 further toward the inner side at the tip end portion, From among FIGS. 5(b), (c), and (d), and from among the end portions 3, the portion that has an angle different than a portion that is at a right angle or is slanted from the main body portion 2, and extends in parallel with the front face of the main body portion corresponds to the “third end portion” in the claims.

As illustrated in FIG. 2, an adhesive layer 4 adheres and secures the main body portion 2 to the adhering surface 50a. The adhesive layer 4 is disposed on at least one portion of the back face 2b side of the main body portion 2. The adhesive layer 4 may be laminated on the entire back face of the main body portion 2. In the present embodiment, the adhesive layer 4 is laminated on the back face 2b of the main body portion 2 and the back face 3b of the end portions 3. The adhesive layer 4 is disposed on almost the entire back face 2b of the main body portion 2. Furthermore, the adhesive layer 4 is disposed on almost the entire back face 3b of the end portions 3. However, the adhesive layer 4 may be disposed on only one portion of the back faces 2b and 3b, or may not be disposed on the back face 3b of the end portions 3 at all.

### Layer Configuration of the Adhesive-Backed Decorative Article

Next, the layer configuration of the adhesive-backed decorative article 1 will be described. The main body portion 2 includes a substrate layer 6, and a front face protective layer 7 laminated on the substrate layer 6. The front face protective layer 7 covers almost the entirety of the substrate layer 6. The front face protective layer 7 has a front face 2a that is the design face and a back face 2b. Therefore, an adhesive layer (adhesive portion) 4 is laminated on the back face 2b of the front face protective layer 7. The end portions 3 include a substrate layer 8 and a front face protective layer 9 laminated on the substrate layer 8. The front face protective layer 9 covers almost the entirety of the substrate layer 8. The front face protective layer 9 has a front face 3a that is the design face and a back face 3b. Therefore, the adhesive layer 4 is laminated on the back face 3b of the front face protective layer 9. A peelable application film layer may be on the front face side of the front face protective layer 9. A peelable liner film layer may be on the back face side of the adhesive layer 4. A design layer such as a pattern or logo by printing, coating of bicycle paint color, or a metal deposition replicating a metal appearance, a base layer for performing a design layer, a joining layer strengthening the adhesion between layers, and the like may be provided between the substrate layer 6 and the front face protective layer 9 or between the substrate layer 6 and the adhesive layer 4.

The main body portion 2 and the end portions 3 use a sheet-shaped member with the adhesive portion 4 attached, and the end portions 3 are formed by bending an end portion of the sheet-shaped member. In this case, the substrate layer 6 of the main body portion 2 and the substrate layer 8 of the end portions 3 are configured as an integrally formed layer connected together. Furthermore, the front face protective layer 7 of the main body portion 2 and the front face protective layer 9 of the end portions 3 are configured as an integrally formed layer connected together. Therefore, in the present embodiment, the substrate layer 6 of the main body portion 2 and the substrate layer 8 of the end portions 3 are configured by a uniform material. The front face protective layer 7 of the main body portion 2 and the front face protective layer 9 of the end portions 3 are configured by a uniform material. However, the substrate layer 6 of the main body portion 2 and the substrate layer 8 of the end portions 3 may be configured by a different material. The front face protective layer 7 of the main body portion 2 and the front face protective layer 9 of the end portions 3 may also be configured by a different material.

Note that a sheet-shaped member without the adhesive layer 4 laminated thereon may be used, and the adhesive layer 4 may be laminated after bending. Alternatively, the end portion 3 may not be formed by bending the end portion of the sheet-shaped member.

### Various Characteristics of the Adhesive-Backed Decorative Article

The main body portion 2 is deformed based on the shape of the adhering surface 50a, and can be adhered and secured to the adhering surface 50a via the adhesive layer 4 without going through a substantial inelastic deformation.

The main body portion 2 deforms to follow the shape of the adhering surface 50a when adhering the adhesive-backed decorative article 1 to the adhering surface 50a. In the present embodiment, the main body portion 2 extends along the longitudinal direction (first direction) and can be curved in the longitudinal direction. In this case, the operator can easily curve the main body portion 2 to follow the curved shape of the adhering surface 50a without applying excessive pressure to the adhesive-backed decorative article 1. Note that in the present specification, when the main body portion 2 (or adhesive-backed decorative article 1 ) “bends” or “curves”, this refers to curving so that the front face 2a and the back face 2b become round.

For example, the adhesive-backed decorative article 1 may have bending rigidity of 0.05 to 2.5 N, 0.10 to 2.0 N, or 0.30 to 1.0 N. “Bending rigidity” mentioned here is defined as the greatest load measured after making an adhesive-backed decorative article protrude a regulated length in the longitudinal direction and secured to the base thereof, and bending the tip end portion in a direction perpendicular to the main plane, as in the JIS L-1096 bending repulsion A method. When the width exceeds 25 mm, this value can be found by dividing it into sections in the width direction, with each section being less than 25 mm, measuring the value of each section, and taking the weighted average of the measured value of each width. By the adhesive-backed decorative article 1 having this bending rigidity, the main body portion 2 can deform based on the shape of the adhering surface 50a, and it can be adhered and secured to the adhering surface 50a via the adhesive layer 4. However, the bending rigidity of the adhesive-backed decorative article 1 is not limited to the above range. The tensile elongation strength of the adhesive-backed decorative article 1 at 2% may be 20 N/10 mm width or greater, 40 N/10 mm width or greater, 60 N/10 mm width or greater, or 80 N/10 mm width or greater. “tensile elongation strength” mentioned here is defined as the load after cutting to 10 mm along the longitudinal direction of the adhesive-backed decorative article, gripping with a stretch test mechanism, and stretching at intervals of 50 mm at a speed of 300 mm per minute for 9 hours. By the adhesive-backed decorative article 1 having such stretching strength, the main body portion 2 can be made to not substantially deform by stretching. However, the tensile elongation strength of the adhesive-backed decorative article 1 at 2% is not limited to the above range.

To make the bending rigidity and tensile elongation strength of the adhesive-backed decorative article 1 follow the above conditions, for example, the material of the substrate layer 6 of the main body portion 2 and the substrate layer 8 of the end portions 3 may be polycarbonate, and the front face protective layer 7 of the main body portion 2 and the front face protective layer 9 of the end portions 3 may be polyurethane. Furthermore, the combined thickness of the main body portion 2 and the adhesive layer 4 may be 0.20 to 1.20 mm, or may be 0.30 to 1.00 mm. The combined thickness of the end portions 3 and the adhesive layer 4 may be 0.20 to 1.20 mm, or may be 0.30 to 1.00 mm. More specifically, the substrate layer 6 of the main body portion 2 may be 0.15 to 1.15 mm. The front face protective layer 7 of the main body portion 2 may be 0.03 to 0.10 mm. The substrate layer 8 of the end portions 3 may be 0.15 to 1.15 mm. The front face protective layer 9 of the end portions 3 may be 0.03 to 0.10 mm. However, as long as the bending rigidity and tensile elongation strength can follow the above conditions, the material, dimensions, and the like of each substrate may be changed in any manner.

The main body portion 2 may include a resin layer with a glass transition temperature of 130° C. or greater. This may be a resin layer wherein the glass transition temperature of at least the substrate layers 6 and 8 from among the main body portion 2 is 130° C. or greater. By using a resin layer with a glass transition temperature of the above temperature or greater, the heat resistance necessary for using in a vehicle can be maintained. To fulfill the above conditions, for example, the material of the substrate layers 6 and 8 may be polycarbonate with a glass transition temperature of 150° C. or greater. When, for example, disposing the adhesive-backed decorative article 1 for 240 hours in an atmosphere of 80° C., and applying polycarbonate as the material of the main body portion 2, the front face 2a did not deform or the like, and favorable conditions were maintained. Meanwhile, when a resin with a glass transition temperature lower than 130 ° C. was applied as the material of the main body portion 2, the deformation of the front face 2a after performing similar tests was greater compared to when polycarbonate was used. When, for example, ABS resin with a glass transition temperature of 80 to 125° C., acrylic (PMMA) resin with a glass transition temperature of 90° C., and PVC resin with a glass transition temperature of 87° C. were applied, the deformation of the front face 2a was large. When PET resin with a glass transition temperature of 69° C. was applied, the deformation of the front face 2a was even larger. Note that it may be a resin other than polycarbonate if it is a resin layer with a glass transition temperature of 130° C. or greater. The conditions described in this paragraph are not necessary conditions for the adhesive-backed decorative article 1, and the above conditions may not be fulfilled

The surface roughness of the front face 2a may be substantially the same before and after adhering the adhesive-backed decorative article 1 to the adhering surface 50a. “Surface roughness being substantially the same” refers to there being no effects on the surface roughness of the front face 2a by the main body portion not being affected by unevenness of the adhering surface 50a underneath. The above characteristics are achieved by making the bending rigidity of the adhesive-backed decorative article 1 to be 0.05 to 2.5 N, 0.10 to 2.0 N, or 0.30 to 1.0 N. For example, when a thin film with low bending rigidity is adhered to the adhering surface 50a, the surface roughness of the film becomes rougher because it is affected by the uneven shape of the adhering surface 50a underneath. The conditions described in this paragraph are not necessary conditions for the adhesive-backed decorative article 1, and the above conditions may not be fulfilled.

The sharpness of the front face 2a of the main body portion 2 after the adhesive-backed decorative article 1 has been adhered to the adhering surface 50a may be set to, for example, 0.5 or greater, or 0.7 or greater. Note that the sharpness of the front face 2a of the main body portion 2 can be measured by a portable total sharpness/glossiness PGD-IV (manufactured by Japan Color Research Institute) as the sharpness before and after adhering to the adhering surface, by adhering the main body portion 2 to a coated plate with a sharpness of 0.2, the coated plate being made by spray coating an outer panel coating to a flat steel plate and baking. To make the sharpness of the front face 2a after adhering to the adhering surface 50a the above value, there is a condition of the adhesive-backed decorative article 1 having bending rigidity only enough to not be affected by the uneven shape of the adhering surface 50a as described above, in addition to the condition of adjusting the material that configures the front face 2a itself. For example, when configuring the substrate layer 6 of the main body portion 2 with polycarbonate, setting the thickness to 0.5 mm, and applying polyurethane as the front face protective layer 7, the sharpness of the front face 2a after adhering is 0.9. Note that when adhering a high gloss/blackout film to the adhering surface 50a, the sharpness is 0.2. The conditions described in this paragraph are not necessary conditions for the adhesive-backed decorative article 1, and the above conditions may not be fulfilled

The front face 2a of the main body portion 2 may have high scratch resistance. In other words, the front face 2a of the main body portion 2 may be not as susceptible to scratches, and have a restoring force that returns to the original state even if a scratch occurs when being cleaned with a sponge or the like. For example, the above scratch resistance can be achieved when the material of the substrate layer 6 of the main body portion 2 and the substrate layer 8 of the end portions 3 is polycarbonate, and the material of the front face protective layer 7 of the main body portion 2 and the front face protective layer 9 of the end portions 3 is polyurethane. The conditions described in this paragraph are not necessary conditions for the adhesive-backed decorative article 1, and the above conditions may not be fulfilled.

The pencil hardness of the front face 2a of the main body portion 2 may be high, and may be, for example, B or higher. The pencil hardness is measured following JISK5600-5-4. For example, when the material of the front face protective layer 7 of the main body portion 2 and the front face protective layer 9 of the end portions 3 is polyurethane, deformability can be prevented from conveying to the substrate layer underneath when tracing with a pencil. For example, the pencil hardness of a high gloss/blackout film is less than 4B. The conditions described in this paragraph are not necessary conditions for the adhesive-backed decorative article 1, and the above conditions may not be fulfilled.

The front face 2a of the main body portion 2 may have high weather resistance. The surface glossiness should be maintained at 80% or more when, for example, the adhesive-backed decorative article 1 is disposed outside for a period of two years. For example, when the material of the front face protective layer 7 of the main body portion 2 and the front face protective layer 9 of the end portions 3 is polyurethane, high weather resistance can be achieved, and the surface glossiness can be maintained at 88% even after disposing outside for a period of five years. The conditions described in this paragraph are not necessary conditions for the adhesive-backed decorative article 1, and the above conditions may not be fulfilled.

The main body portion 2 may have high deformability due to stamping for the bending process that forms the end portions 3. In other words, cracks should not occur when the end portions are bent by stamping. For example, cracks do not occur when the material of the front face protective layer 7 of the main body portion 2 and the front face protective layer 9 of the end portions 3 is polyurethane, but cracks do occur with a PMMA resin. Furthermore, the material of the front face protective layers 7 and 9 may have elasticity under temperature conditions of 80° C. For example, cracks should not occur in the protective layers 7 and 9 even after the adhesive-backed decorative article 1 bent by stamping is disposed for 240 hours in an atmosphere of 80° C. The front face protective layers 7 and 9 have rupture elongation of 100% or greater at 80° C.

The adhesive-backed decorative article 1 may have sufficient cleavability after being adhered to the B pillar 50. For example, a hook is hooked onto the tip end portion of one of the end portions 3 of the adhesive-backed decorative article 1, which has been adhered to the B pillar 50, and a pulling force is applied by pulling in a direction perpendicular to the front face 2a of the main body portion 2. At this time, the state of the adhesive-backed decorative article 1 being adhered to the B pillar 50 should be maintained even if a pulling force of 40 N or greater is applied. Specifically, the cleavability may be raised by adjusting the adhesive strength by adjusting the material or application area of the adhesive layer 4. In this case, the cleavage strength may be set to 60N or greater, or 80N or greater. Alternatively, cleavability may also be raised by a pulling force of the end portions 3 when the end portions 3 are formed in a U-shape to surround the B pillar 50 as in FIGS. 5(b) and (d). The conditions described in this paragraph are not necessary conditions for the adhesive-backed decorative article 1, and the above conditions may not be fulfilled.

When the end portions 3 are formed in a U-shape to surround the B pillar 50 as in FIGS. 5(b) and (d) as described above, it is necessary for the adhesive layer 4 to slide on the adhering surface 50a, with the adhesive layer 4 contacting the adhering surface 50a when adhering to the B pillar 50. By this, the end portion of the U-shape can be hooked onto the edge portion of the B pillar 50. Therefore, the adhesive layer 4 may have sufficient slidability with the adhering surface 50a. For example, the slidability may be improved by the adhesive layer 4 having a microstructured surface. Specifically, a groove of a prescribed pattern formed on the microstructured surface has a prescribed volume of at least 1×10 m, in a circular region with a radius of 500 m set in any location corresponding to the pattern. According to this structure, slidability can be improved by reducing the contact area between the adhesive face 4 and the adhering surface 50a while sliding by the groove. A force sufficient to secure can be assured after positioning is complete by pressing the main body portion to the adhering surface 50a. Alternatively, slidability while sliding may also be improved by mixing in padhesive-backed decorative articles such as glass beads into the adhesive layer 4. The conditions described in this paragraph are not necessary conditions for the adhesive-backed decorative article 1, and the above conditions may not be fulfilled

### Material of the Adhesive-Backed Decorative Article

The substrate layer 6 of the main body portion 2 and the substrate layer 8 of the end portions 3 are smooth, hard, and thick, and the material thereof may be thermoplastic resin. That is to say, the main body portion 2 and the end portions 3 have a configuration including thermoplastic resin. For example, polycarbonate, non-stretched PET, ABS, rigid PVC, and the like, or a compound of these may be applied as a thermoplastic resin. Alternatively, the substrate layers 6 and 8 may be configured by layering layers of a plurality of types from among the above materials. Polycarbonate, and a compound of polycarbonate and another thermoplastic resin other than polycarbonate are particularly preferable because they excel in heat resistance. The ability to maintain the shape having undergone the bending process is reduced if the substrate layer is to thin, and surface smoothness is lost when unevenness occurs on the base material after adhering. The bending process becomes difficult if the substrate layer is too thick. Furthermore, only items with a large curvature on the outer face side of the bent portion can be made, and reproductivity is lost. Furthermore, it becomes difficult to make in a coil form, which is advantageous for continually processing. The thickness of the substrate layers may be 0.2 to 1.5 mm, preferably 0.3 to 1 mm, and more preferably 0.4 to 0.8 mm.

The front face protective layer 7 of the main body portion 2 and the front face protective layer 9 of the end portions 3 may include polyurethane. In other words, the main body portion includes a polyurethane layer as the front face protective layer 7, and the end portions 3 include a polyurethane layer as the front face protective layer 9. An object that has reacted with, for example, one of a non-yellowing polyester polyol, glycol, polycaprolactone polyol, polycarbonate diol, acrylic polyol, or a compound of these, and IPDI (isophoron diisocyanate), hydrogenated MDI (4,4′- cyclohexyl methane diisocyanate), hydrogenated XDI (xylylene diisocyanate), HDI (hexamethylene diisocyanate) or its polymer, or a compound of these, and the like may be applied as polyurethane. Furthermore, the material of the front face protective layer 7 of the main body portion 2 and the front face protective layer 9 of the end portions 3 may have polycarbonate diimide, aziridine, or the like cross-linked with non-yellowing water-based polycarbonate polyurethane. Furthermore, the front face protective layer 7 of the main body portion 2 and the front face protective layer 9 of the end portions 3 may be colored by mixing a coloring agent such as carbon black with the resin described above. In the present embodiment, the front face protective layer 9 is colored in black, but the color is not particularly limited. The front face protective layers 7 and 9 may be configured by layering a layers of a plurality of types from among the above materials. Furthermore, when using outdoors, the material of the front face protective layer 9 should be selected with weather resistance in mind, with little change in the seven colors and little change in gloss after using outdoors for multiple years. It is preferable for the material of the front face protective layer 9 to also have a high rupture elongation in high temperatures wherein cracks do not occur even if exposed in a high temperature environment such as 80° C. after stretching by bending. As this type of polyurethane composition, polyurethane due to a reaction with polycaprolactone polyol and an IPDI isocyanurate body in the working example of JPA H05-155976, polyurethane due to a polymer three-component reaction of polycaprolactone diol, polycarbonate diol, and IPDI in claim 1 of JPA 2007-297569, polyurethane that is cross-linked with polycarbodiimide after chain length extending polycarbonate diol, carboxyl group containing aliphatic diol, and hydrogenated MD in claim 1 of WO 2013/173424, or the like; all the above having properties of a rupture elongation of 100% or more (two times or more the original length) in an accelerated weathering test common for an automobile exterior (SWOM 2000h, Xenon 750MJ), or a tensile test being exposed outdoors for one year with a gloss retention ratio of 80% or more, a color difference value of 3 or more, in an atmosphere of 80° C. or 120° C. If the front face protective layers 7 and 9 are too thin, and the function of protecting the lower layers such as the substrate layer from scratches, chemicals, and ultraviolet light is reduced. If the front face protective layers 7 and 9 are too thick, local force during the bending operation is absorbed by deforming, and reproductivity is reduced. The thickness of the front face protective layers may be 0.003 to 0.2 mm, preferably 0.01 to 0.1 mm, and more preferably 0.02 to 0.07 mm.

By providing a peelable application film such as, for example, PET film, to the front face side in addition to the front face protective layers 7 and 9, deformation, scratching, and adhesion of dirt on the front face protective layers can be prevented during the bending process, during construction, and during storage and transportation. Biaxial stretching is preferred for the PET film. An easily moldable PET film can also be used that can easily stretch at normal temperatures or high temperatures. By setting the gloss of the front face of the PET film that contacts the front face protective films 7 and 9, it is possible to design the surface gloss of the front face protective layers that appear after the gloss has peeled away from a high gloss to a low gloss. If the PET film is to thin, the function of preventing deformation of the front face protective layers 7 and 9 such as dents that occur during bending, construction, or transportation is reduced. If the PET film is too thick, reproductivity is reduced by preventing local stretching during the bending process. The thickness of the PET film may be 0.006 to 0.288 mm, preferably 0.016 to 0.125 mm, and more preferably 0.025 to 0.075 mm.

The adhesive layer 4 may be configured by an adhesive agent such as a pressure sensitive, heat sensitive, two component curing, one component moisture curing adhesive agent. Note that the adhesive layer 4 may be configured by a pressure sensitive adhesive (a so-called agglutinant) such as an acrylic, rubber-based, silicone-based, polyolefin adhesive or the like. An acrylic or silicone based adhesive is preferred that has no limitation on usable period of the product, where pressure sensitivity that does not need heating or reaction time excels in practicality, and excels in durability when used outdoors. Acrylic based adhesive is particularly preferable in terms of economic efficiency and various characteristics that are desired in the market. If the adhesive layer 4 is too thin, the adhesive area on the base material face is reduced, and adhesion is reduced by the volume that deforms by the peeling force particularly with a pressure sensitive adhesive being small. If the adhesive layer 4 is too thick, force is absorbed into the adhesive layer 4 during the bending process, it becomes difficult to perform the bending process, and reproductivity is reduced. The thickness of the adhesive layer is 0.005 to 0.4 mm, preferably 0.01 to 0.15 mm, and more preferably 0.02 to 0.075 mm. The joining strength of the adhesive layer 4 is the joining strength where a shape can be maintained when the adhesive-backed decorative article 1 is adhered to after being deformed. Specifically, it is preferable for the adhesion after adhering the adhesive-backed decorative article 1 on a vehicle outside plate coat and peeling in a 90 direction after 48 hours at a speed of 300 mm/min to be 5 N/25 mm or greater, more preferably 10 N/25 mm or greater, and even more preferably 15 N/25 mm or greater.

A peeling liner may also be provided on the back face side of the adhesive layer 4. The adhesive layer 4 is especially useful to prevent the adhesion of foreign substances when with a pressure sensitive adhesive. A microstructured adhesive surface, such as Japanese Patent 3550096 or WO 98/29516, is adhered to the front face of this peeling liner, and slidability and air venting properties are given during adhering by transferring this to the adhesive layer 4. By partially providing a layer including glass beads like that in Japanese Patent 3820438 and transferring to the adhesive layer 4, functionality such as slidability with the base material during adhering, and improved positioning can be given. If the peeling liner is too thin, performance for preventing the adhesive layer from deforming due to a local force during the bending process, and if the peeling liner is too thick, stretching during the bending is prevented and it becomes difficult for heat to conduct, and in either case, reproductivity is reduced. The thickness of the peeling liner is 0.01 to 0.3 mm, preferably 0.02 to 0.2 mm, and more preferably 0.05 to 0.015 mm. The adhesive layer 4 may have a microstructured surface. A groove of a prescribed pattern formed on the microstructured surface may have a prescribed volume of at least 1×103 3m set in any location corresponding to the pattern.

### Manufacturing Method

Next, an example of the manufacturing method of the adhesive-backed decorative article 1 will be described. However, the manufacturing method of the adhesive-backed decorative article 1 is not limited to the method below.

The manufacturing method of the adhesive-backed decorative article 1 has a step for preparing a sheet-shaped member 100 with an adhesive attached that has a front face 2a to become the design surface (sheet preparing step), and a bending step for bending the end portions 3 of the sheet-shaped member 100 and forming a fixed angle relative to the front face 2a.

In the sheet preparing step, the entire face of a substrate layer (layer corresponding to the completed substrate layers 6 and 8) is covered by a front face protective layer (layer corresponding to the completed front face protective layers 7 and 9), and the sheet-shaped member 100 is prepared with an adhesive laminated on one face (face corresponding to the completed back face 2b). Specifically, the adhesive layer is molded in a constant thickness and size by a method such as an extrusion method wherein a thermoplastic resin is discharged from between a gap of a constant thickness from a state where it is melted at a temperature higher than the melting point, a calendar method that passes through two rolls adjusted with a constant gap, or the like. When including a solvent after applying an adhesive solution to one face of the substrate layer by a barcode, roll coat, gravure coat, spray coat method or the like, and everything but the solvent is coated by inserting into a hot air oven for a predetermined period of time. When the adhesive coat film has stickiness, and especially when it is a pressure sensitive adhesive, the adhesion of foreign substances can be prevented, and the adhesive coat film can be layered in a sheet, or wound into a rolled shape, by laminating the peeling liner directly after the coat filming. The substrate layer can also be laminated after applying the adhesive layer to the peeling liner. When laminating the front face protective layer on the face opposite the substrate layer, coat filming can be done by performing drying or curing if necessary after directly applying the solution for the front face protective layer by a barcode, roll coat, gravure coat, spray coat, or the like, the front face protective layer can be made a cured coat film by inserting into a hot air oven directly after applying when it is solvent-based two liquid curing type urethane, and polyurethane does not react without the solvent, the reaction proceeds by storing the PET film with stickiness at room temperature after laminating, becoming a polyurethane coat film without stickiness, and the PET film can then be peeled. When the front face protective layer is water-based polyurethane, it is first applied on the PET film, and after drying and being made into a coat film, this can be laminated to the substrate layer via a joining layer such as polyurethane, polyester, or polyamide. Films such as ionomer, EAA (ethylene-ethyl acrylate copolymer), PVdF and PMMA copolymer, ETFE (ethylene tetrafluoroethylene copolymer) can be laminated via a joining layer individually or with a PET film previously laminated thereon. The order of the laminating of the front face protective layer and the laminating of the adhesive layer does not matter. Before layering the front face protective layer or layering the adhesive layer, a design may be given, a shape may be printed on the substrate layer, a colored layer may be applied, a colored film may be adhered, or a metal deposition or a film of a plurality of layers including a metal deposition may be adhered. To improve the adhesion and durability between layers, an additional layer can be provided, such as applying a primer.

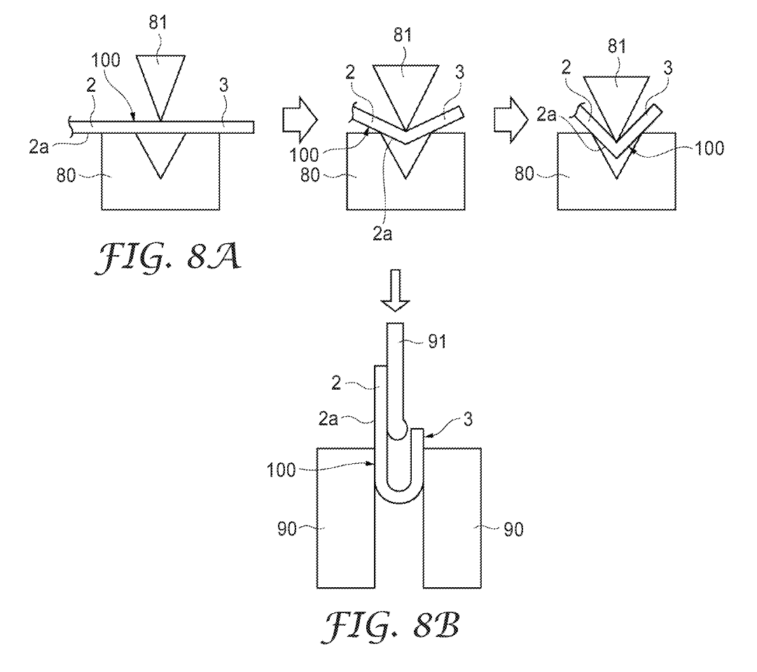

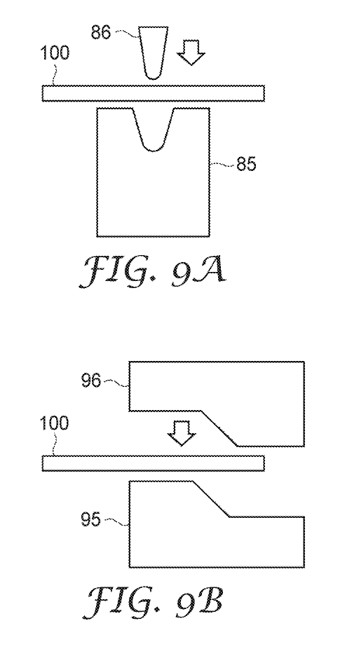

The bending step may be carried out by, for example, stamping. When applying stamping, the bending step is provided with a step for preparing a pair of molds 80 and 81, a step for securing a sheet-shaped member 100 to the one mold 80, and a step for forming a fixed angle relative to the sheet-shaped member 100 by relatively moving at least one of the one mold 80 or the other mold 81, as illustrated in FIG. 8(a). The one mold 80 has a v-shaped groove portion, and the other mold 81 has a shape that can enter the groove portion. Therefore, the other mold 81 enters the groove portion of the one mold 80, and the sheet-shaped member 100 can be bent along the groove portion. By this step, the end portion 3 is formed having a fixed angle relative to the main body portion 2. The angle of bending can be adjusted by adjusting the amount of relative movement between the mold 80 and the mold 81. The bending step may be carried out at 80° C. or higher. For example, even if the sheet-shaped member 100 includes a material with high heat resistance to improve the heat resistance of the completed product, stress is relaxed, and the bending process can be easily done by stamping, by carrying out the bending step at 80° C. or higher. Furthermore, the bent end portion 3 can be prevented from returning to its original shape. By heating one side or both sides of the mold, and holding it for a fixed period of time after stamping, the sheet-shaped member 100 may be heated by the heat transferring to the sheet-shaped member 100. For example, by making the tip end of the groove portion a bent face as in molds 85 and 86 illustrated in FIG. 9(a), the cross-sectional shape of the bent portion of the sheet-shaped member 100 can be adjusted to match, for example, the shape of the base material to be adhered. If bending is performed after heating the mold, there is the advantage of heat easily transferring to the sheet-shaped member 100, to the extent that the contact area of the mold 86 in FIG. 9(a) is wider than the contact area of the mold 81 in FIG. 8. When performing stamping after heating the mold 86, the heating may be carried out with a mold temperature of 120 to 150° C.

Furthermore, when bending the end portion in an approximate U-shape, molds 90 and 91 illustrated in FIG. 8(b) may be used. As illustrated in FIG. 8(b), the bending step is provided with a step for preparing the pair of molds 90 and 91, a step for securing the sheet-shaped member 100 to the one mold 90, and a step for forming a fixed angle relative to the sheet-shaped member 100 by relatively moving at least one of the one mold 90 or the other mold 91. The one mold 90 has a groove portion having side faces that oppose each other in parallel, and the other mold 91 has a shape that coils around the sheet-shaped member 100 and can enter the groove portion. Therefore, the other mold 91 enters the groove portion of the one mold 90, and the sheet-shaped member 100 is bent along the groove portion in an approximate U-shape. By this step, the end portion 3 is formed having a fixed angle relative to the main body portion 2. When performing stamping using the mold 90 illustrated in FIG. 8(b), this may be carried out with the temperature of the mold 91 at approx. 120 to 170° C. Stress may be relaxed by heating the bent outer face of the sheet-shaped member 100 via hot air, infrared rays, water vapor or the like from the opening portion of the mold 90 after stamping. When bending the end portion in a shape to connect a plurality of faces and between them with a slanted face, the molds 95 and 96 illustrated in FIG. 9(b) may be used. While the end portion of the sheet-shaped member 100 is inserted between the molds, the molds are closed and parallel mountain folds and valley folds are performed simultaneously. This may be carried out with the temperature of the molds 95 and 96 at 100 to 135° C.

### Adhering Method

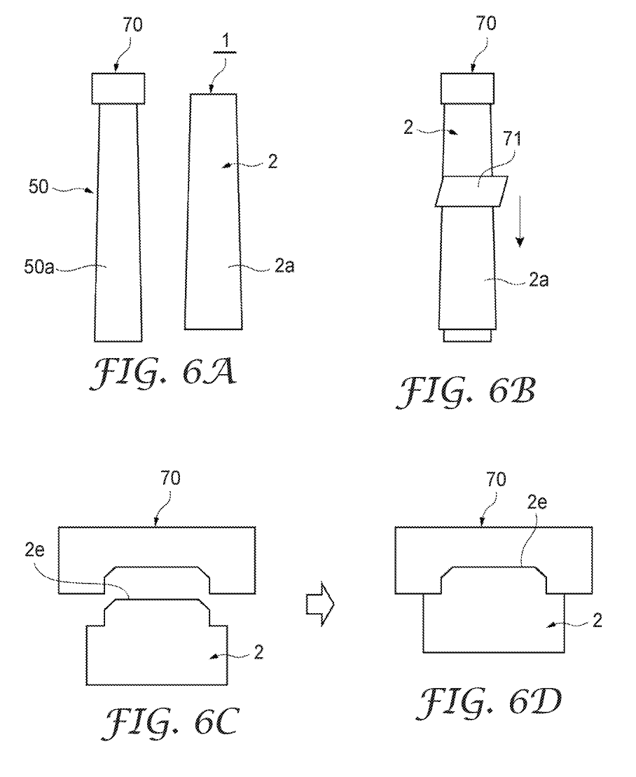

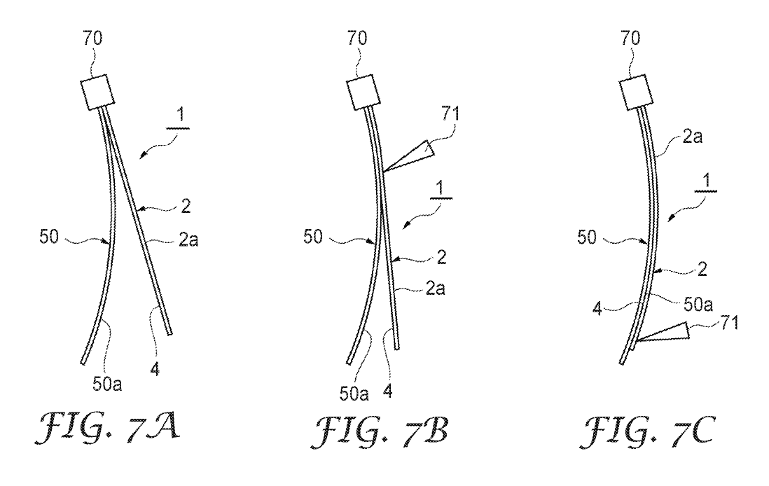

Next, the method for adhering the adhesive-backed decorative article 1 to the adhering surface 50a of the B pillar 50, which is the adhesive-backed decorative article, will be described referring to FIG. 6 and FIG. 7. A description will be given of a method wherein the adhesive-backed decorative article 1 has, for example, the end portion shape illustrated in FIGS. 5(a), (c). This method has a step for preparing the adhesive-backed decorative article 1 provided with the main body portion 2 having a front face 2a to become the design face and the back face 2 b, the end portion that extends from one side of the main body portion 2 and has a front face 3a forming a fixed angle relative to the front face 2a of the main body portion, and disposed on at least one portion of the back face 2b side of the main body portion 2, a step for deforming the main body portion 2 based on the shape of the adhering surface 50a, and adhering and securing it to the adhering surface via the adhesive layer 4 without going through a substantial inelastic deformation. Furthermore, the securing step includes a step for positioning the end portion 3 and the end portion of the adhering surface 50a.

As illustrated in FIG. 6(a), in the securing step, a jig 70 is installed for supporting the adhesive-backed decorative article 1 on the upper end portion of the B pillar 50. As illustrated in FIG. 6(b) and FIG. 7(a), the upper end portion of the adhesive-backed decorative article 1 is secured to the jig 70 in the first stages of the securing step. At this time, the adhesive-backed decorative article 1 is fixed to the jig 70 while positioning the end portion 3 and the end portion of the adhering surface 50a. Note that when the front face of the adhesive layer 4 is covered by a liner, the liner may be peeled off When fixing the adhesive-backed decorative article 1 to the jig 70, for example, positioning may be performed by fitting the upper end of the adhesive-backed decorative article 1 on a groove portion of the jig 70, as illustrated in FIG. 6(c). However, the supporting structure of the jig 70 is not particularly limited, and a structure may be applied where a plurality of slits is formed on the jig 70, a plurality of protruding portions are formed on the upper end of the adhesive-backed decorative article 1, and each protruding portion of the adhesive-backed decorative article 1 is inserted into each slit of the jig 70.

As illustrated in FIG. 6(b) and FIG. 7(b), after supporting the upper end of the adhesive-backed decorative article 1 with the jig 70, the operator can move a squeegee 71 up to down while the main body portion 2 is pressed to the adhering surface 50a by pressing the front face 2a of the main body portion 2 with the squeegee 71. By this, the main body portion 2 is adhered to the adhering surface 50a via the adhesive layer 4 while deforming it based on the shape of the adhering surface 50a (here, a curved shape) In this step, the main body portion 2 can be easily deformed along the adhering surface 50a even if the operator does not apply an excessive force. As illustrated in FIG. 7(c), the entirety of the adhesive-backed decorative article 1 is adhered to the adhering surface 50a by the operator pressing the front face 2a with the squeegee 71 until it reaches the lower end of the main body portion 2, completing the securing step.

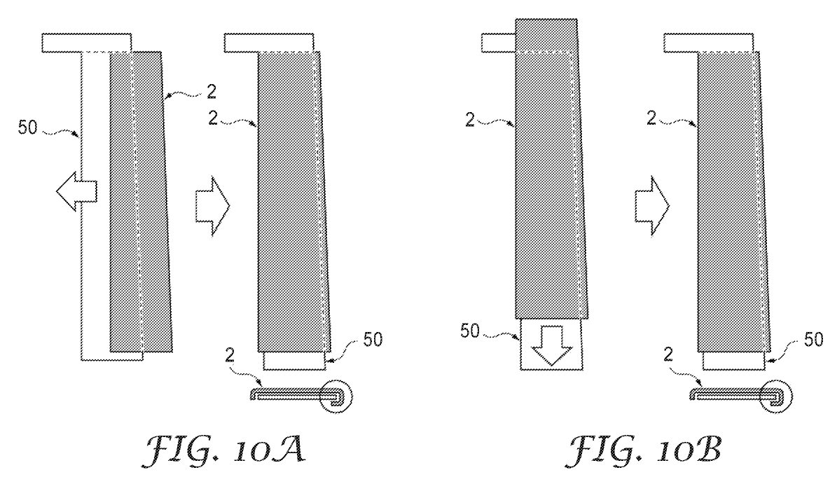

Next, a description will be given of a method wherein the adhesive-backed decorative article 1 has, for example, the end portion shape illustrated in FIGS. 5(b), (d). When bending the end portion of the sheet-shaped member 100 in a U-shape and constructing to wind around a substrate's plate-shaped adhering body end portion such as a metal plate called a hemming being bent and flattened with no gaps, the U-shaped end face of the sheet-shaped member 100 slides from the end portion side of the base material to be finally inserted, and the surface is pressed with the squeegee and adhered when it collides, as illustrated in FIG. 10(a). As illustrated in FIG. 10(b), when the adhering body is a trapezoid shape as with an automobile center pillar, it may be made to slide to insert from the thin side (upper end side). In any case, construction becomes simpler by achieving slidability with the front face of the adhering body, when the adhesive layer is a pressure sensitive adhesive. By transferring nonadhesive components that have been partially performed on the peeling liner to the front face of the adhesive layer, and by preventing the pressure sensitive adhesive layer from directly touching the adhering body, slidability is achieved, and after positioning, the nonadhesive components are pressed into the pressure sensitive adhesive layer with pressure, and the pressure sensitive adhesive layer is adhered to the adhering surface of the substrate. Alternatively, by placing a thin sheet that has a peel component on its surface, or that has fine unevenness to reduce the contact area with the surface, on a pressure sensitive adhesive layer other than one bent in a U shape, it can slide while preventing contact with the pressure sensitive adhesive layer and the adhering surface of the substrate, and the sheet can be pressed by pulling on the side opposite the U-shaped end portion, after positioning is complete.

According to the adhesive-backed decorative article of the present embodiment, the main body portion 2 is deformable based on the shape of the adhering surface 50a, and it can also be adhered and secured to the adhering surface 50a via the adhesive layer 4 without substantially stretching. In other words, the main body portion 2 will not deform by stretching even if an operator pulls on the main body portion 2 when adhering to the adhering surface 50a. Furthermore, the main body portion 2 does not need to be pulled so that it does not sag down due to its own weight because it has the ability to maintain its shape. Moreover, the main body portion 2 is deformed based on the shape of the adhering surface 50a because it is given an appropriate amount of rigidity, and can be adhered and secured to the adhering surface 50a via the adhesive layer 4. Therefore, when the operator deforms the main body portion 2 based on the shape of the adhering surface 50a and adheres the adhesive-backed decorative article 1 to the adhering surface 50a, it is not necessary to perform a position adjustment by pulling and stretching the main body portion 2, which is different than when using a conventional extensible film. Because the end portion 3 has a front face 3a forming a prescribed angle with a front face 2a of the main body portion, the operator does not need to bend the end portion 3 when adhering. Moreover, it is not necessary to form the shape of the main body portion 2 in advance into something that corresponds based on the shape of the adhering surface 50a, as with when forming the adhesive-backed decorative article by a method such as injection molding, and the adhesive-backed decorative article 1 can be adhered to the adhering surface 50a regardless of the shape of the adhering surface 50a. By the above, the adhering of the adhesive-backed decorative article 1 to the adhering surface 50a can be performed easily, which improves the handleability of the adhesive-backed decorative article 1. Moreover, because the adhesive layer is at least adhered on the entire main planar adhering surface of the substrate, and there is no space between the adhering surface of the substrate, because it contacts the entire surface, there is no need to make it thick and hard like a conventional garnish, making a configuration possible that is thin and light, and there is no need to make holes on the adhering surface side.

Furthermore, with the adhesive-backed decorative article 1, the bending rigidity may be 0.05 to 2.5 N. In this case, the main body portion 2 is deformed based on the shape of the adhering surface 50a, and can be a configuration that can be adhered and secured to the adhering surface 50a via the adhesive layer 4. If the bending rigidity is too low, it becomes difficult to maintain the shape of the end portion bending process, and if the bending rigidity is too high, it becomes impossible to deform following the shape of the adhering surface 50a. Alternatively, even if bent to follow it with a strong force, the stress to return to the original shape is too strong, and it peels from the adhering surface of the substrate due to the passage of time or high temperatures. The adhesive-backed decorative article 1 according to the present embodiment is simple to adhere because it has both ability to maintain the bending process shape and a shape that does not sag down due to its own weight by an appropriate bending rigidity, and also ease of deforming while adhering.

Furthermore, in the adhesive-backed decorative article 1, tensile elongation strength at 2% may be 20 N/100 mm width or greater. In this case, the adhesive-backed decorative article 1 can be made to be a configuration that does not substantially stretch. The force of a hand when performing adhering and the like is around 5N 100 mm at the greatest, and corresponds to 5.7 N/10 mm when adhering to a general automobile center pillar with a width of 70 mm. Compared to an adhesive-backed decorative article with a tensile strength of 5 N/100 mm that stretches 2% or more when adhered exerting maximum force, the adhesive-backed decorative article 1 according to the present embodiment does not substantially stretch, making it more difficult to stretch and be off of position even if adhered by hand, making it easy to adhere.

Furthermore, with the adhesive-backed decorative article 1, the width of the main body portion 2 may be 0.2 to 1.0 mm. A thinner, lighter adhesive-backed decorative article is possible when compared to forming an adhesive-backed decorative article by a method such as injection molding. When installed as an automobile center pillar decoration, difference in height with the adjacent front and back glass windows can be made smaller, giving it a sense of homogeneity. The height of the side face being lower also has the possibility of being able to reduce air resistance, and also making it lighter, and an improvement in fuel efficiency can therefore be expected.

### MODIFIED EXAMPLES

For example, in the embodiments described above, a bending by stamping was performed on the sheet-shaped member, but as long as a bending can be performed, any method may be applied. For example, bending may be performed by vacuum molding. Vacuum molding is a method for molding a sheet-shaped member in a shape corresponding to a mold by evacuating air between the mold and the sheet-shaped member. By using a mold that forms a bent shape on the end portion, the end portion of the sheet-shaped member can be bent. However, compared to a bending process by stamping, the portion that cannot be used as the final adhesive-backed decorative article and must be cut off and disposed of becomes larger with vacuum molding.

Moreover, the B pillar (or A pillar or C pillar) to which the adhesive-backed decorative article 1 is adhered is only one example of a substrate having an adhering surface, and any object can be applied as the substrate if it has the need to form a design face. For example, an external component (bumper, mirror) for a vehicle to which one would like the adhesive-backed decorative article to be adhered to, an internal component for a vehicle (dashboard), furniture component, electronic appliance component, or construction component can be applied.

### WORKING EXAMPLE

Below, the adhesive-backed decorative article according to one aspect of the present invention will be described in detail based on working examples, but the configuration of the adhesive-backed decorative article is not limited to these working examples.

### Working Example 1

### Method for Manufacturing the Adhesive-Backed Decorative Article According to the Working Example 1

A polyurethane pre-solution (see table 1 for the proportions) that has been colored black was applied on one 0.5 mm thick face of a polycarbonate sheet EC 105 from Sumitomo Bakelight Co. by a barcode, inserted into a 60° C. hot air oven for a period of five minutes, and an application film (0.05 mm thick Toray Ind. Inc. biaxial stretching PET film T 60) was laminated by a roll laminator. After storing for three days at room temperature, the polyurethane reaction had progressed, the applied polyurethane solution had become a 0.05 mm thick black polyurethane layer front face protective layer) with no surface stickiness, and the PET film could be peeled off. An acrylic pressure sensitive adhesive solution (pressure sensitive adhesive solution with 1.25 parts mass of aziridine curing agent added to a solution of 40% solid content with 90 parts mass of iso-octyl acrylate, and 10 parts mass of acrylic acid polymerized) was applied to the opposite side face of the polycarbonate sheet (substrate layer) by a barcode, inserted into a 80° C. hot air over for a period of ten minutes, making a 0.06 mm thick coat film (adhesive layer), and a Tohcello Co. SP-PET-01-25-BO release treatment PET film with a thickness of 0.025 mm was laminated by a roll laminator. A sheet-shaped member with an adhesive attached was prepared with the following steps. The combined thickness of the main body portion and the adhesive layer of the adhesive-backed decorative article according to working example 1 was 0.61 mm.

TABLE 1
Polyurethan Pre-solution Proportions

| | | Chemical, | Ratio |
|---|---|---|---|
| Name | Supplier | Function | (wt %) |
| Nippollan 983 | Nippon Polyurethane | Polycarbonate | 18.2 |
| | Industry | Diol | |
| | (Tokyo, Japan) | | |
| Placcel 205H | Daicell | Polycaprolactone | 18.2 |
| | (Tokyo, Japan) | Diol | |
| TINUVIN 292 | Chiba Specialty | Photostabilizer | 0.9 |
| | Chemical | | |
| | (Basle, Switzerland) | | |
| TINUVIN 99-2 | Chiba Specialty | Ultraviolet light | 1.8 |
| | Chemical | absorber | |
| | (Basle, Switzerland) | | |
| Dibutyltindilaurate | Tokyo Chemical | Catalyst | 0.018 |
| | Industry | | |
| | (Tokyo, Japan) | | |
| Buthyl acetate | Sankyo Chemical | Solvent | 7.3 |
| | Industry | | |
| | (Tokyo, Japan) | | |
| VESTANAT T | Evonik Japan | Isophorone | 41.6 |
| 1890E | (Tokyo, Japan) | diisocyanate | |
| | | trimer | |
| TT-502 | BASF Japan | Black pigment | 12.1 |
| | (Tokyo, Japan) | | |
| | | sum | 100.0 |

A center pillar of an automobile was prepared as the substrate by a steel plate pressing process and outer plate coat. The upper end of the pillar and the upper end of the adjacent glass window are set to the same height, the width of the upper end of the pillar is 57 mm, the width of the lower end is 77 mm, the height between these two is 450 mm, and the steel plate is folded back at both ends in the width direction in a straight line with a thickness of 2 mm. When viewing from a cross section cut from a plane expanding in the horizontal direction, both ends of the pillar are formed in a half circle with a radius of approximately 1 mm, and between both ends is substantially a plane. When viewing the center pillar from a cross section cutting from a plane expanding in the left and right direction of the car, there is a circular arc with a radius of 620 mm in the direction projecting to the outer side of the car. The sheet-shaped member was cut so that the length of the sheet is a length based on the pillar, and the width is a length extending 1.5 mm from each of the left and right of the width of the pillar. A metal lower mold and upper mold with a length of 500 mm were prepared with a cross section as in molds 85 and 86 illustrated in FIG. 9(a) and each was secured to an upper and lower board face of a press machine. The angle of the blade of the upper mold is approximately 20°, and a cross section of the blade tip is a circular arc with a radius of approximately 1 mm. The cavity of the lower mold is at an angle slightly wider than the upper mold, and is a large circular arc. A heater was attached on the upper mold, and a sheet was placed on a position where the upper mold will hit on the line on an inner side approximately 2.5 mm from the end portion of the cross direction of the sheet with it heated at an actual temperature of 150° C., and the upper and lower molds were closed, held for 10 seconds, and opened again.

The end portion of the opposite side was processed in the same manner. All layers of the processed sheet were bent with both end portions in the cross direction at approximately 90°, the height thereof having inside dimensions of approximately 2 mm, and the inner face of the bent line is a circular arc with a radius of approximately 1 mm when viewed from a cross section. It was confirmed that with the peeling liner peeled off, it did not sag down even when being held horizontally grasping the lower end and that it has the ability to stand maintaining the shape. The upper end of the adhesive-backed decorative article was positioned and crimped on the upper end of the pillar portion by a squeegee from the front side. After crimping the adhesive-backed decorative article in order by passing the squeegee through in the downward direction as is, the adhesive-backed decorative article was bent along the curvature in the vertical direction of the pillar face and maintained its shape by the adhesion of the pressure sensitive adhesive layer, continued to be secured, and was able to be easily adhered without the position being out of place in the cross direction partway through. Both end portions of the pillar were covered by both end bending portions of the shaping sheet by matching the curvature, and after peeling off the PET film of the front face, a good looking, high gloss, black appearance was achieved in the same face shape as the pillar shape. It is a little under 0.6 mm thicker than the pillar face, but this difference in height was barely recognizable with the naked eye. It was understood that the surrounding view after reflecting off the front face was clear, and the surface smoothness was high. Even if viewed under direct sunlight, it appeared as a transparent black with no cloudiness. The weight of the sheet not including the liner and the PET film was 24 g.

### Working Example 2

By changing the liner of working example 1, the adhesive-backed decorative article according to working example 2 was created. The liner of working example 2 is a liner with 0.045 mm thick polyethylene laminated on both faces of a 0.05 mm thick PET film via the adhesive layer, a silicon release treatment agent applied on one of the faces, and an unevenness with a period of approximately 6 μm in depth and approximately 300 μm horizontal and vertical is performed by heat embossing. In working example 2, a sample was created by making the mold temperature of the bending process 120° C. and the holding time 20 seconds.

In working example 2, a sample was achieved that excels in adhesive abilities and surface smoothness with both end portions being bent at approximately 90°, as with working example 1.

### Working Example 3

The adhesive-backed decorative article according to working example 3 makes the thickness of the pressure sensitive adhesive layer of working example 1 to be 0.03 mm, and the length of the right edge cut off is widened 5 mm and folded at 180°. In working example 3, the same steps were performed as working example 1 until the bending step of the left end portion. When bending the right end portion, a sheet was placed on a position where the upper mold will hit on a line on the inner side approximately 7 mm from the end portion in the cross direction of the sheet with the cross section of the mold 91 side of the molds 90 and 91 in FIG. 8(b) heated at 165°, and the upper and lower molds were closed, held for 10 seconds, and opened again. A sample was achieved that is bent so that the left side end portion which was processed first was folded at approximately 90°, and the right side end portion which was processed next was folded at approximately 180°.

In working example 3, it was confirmed that with the peeling liner peeled off, it did not sag down even when being held horizontally grasping the lower end, and that it has the ability to stand maintaining the shape. The molded product was inserted from the right end of the pillar while it was bent matching the curvature of the vertical direction of the pillar, and the front face was clamped with a squeegee when the portion folded at 180° hit the right end of the pillar. Both end portions of the pillar were covered by both end bending portions of the shaping sheet by matching the curvature, and in particular, the right end portion was wound to the back face with an approximate width of 5 mm. After peeling off the PET film of the front face, a good looking, high gloss, black appearance was achieved in the same face shape as the pillar shape.

### Working Example 4

The adhesive-backed decorative article according to working example 4 has a different substrate than working example 1. A center pillar of an automobile was prepared as the substrate of working example 4 by a steel plate pressing process and outer plate coat with a different shape than working example 1. The upper end of the pillar and the upper end of the adjacent glass window are set to the same height, the width of a portion of the upper end is 85 mm, the width of the lower end is 85 mm, the height between these two is 445 mm, and the right end of the width direction has the steel plate folded back in a straight line with a thickness of 2 mm when viewed from the front face side. When viewing from a cross section cut from a plane expanding in the horizontal direction, the right end of the pillar is formed in a half circle with a radius of approximately 1 mm. When viewed from the front face side, the left end makes an approximate quarter circle with a radius of 10 mm with the entire width becoming smaller from the upper end downward approximately 10 mm, and from there to the lower end is a straight line. At approximately a 10 mm width from the end portion is a plane parallel to a main plane portion continuing from the right end (end portion side plane), but it is approximately 2.5 mm lower on the vehicle body side, between the end portion side plane and the main plane is a width of approximately 5 mm, and is a slanted face of approximately 30° slanted from the main plane to the end portion side plane. The angle of this slanted face and the main plane, and the angle between the slanted face and the end portion side plane was a circular arc with a radius of approximately 1 mm when viewed from a cross section cut from a plane expanding in the horizontal direction. When viewing the center pillar from a cross section cutting from a plane expanding in the left and right direction of the car, there is a circular arc with a radius of approximately 1500 mm in the direction projecting to the outer side of the car.

The same sheet as working example 1 was cut from so that the length of the sheet is a length based on the pillar, and the width direction has the right end extended 1.5 mm more than the width based on the pillar, and the left end is a shape that is shortened 4 mm.

A press mold was prepared combining an upper mold and a lower mold having a surface shape where a large bending is possible while considering a spring back when bending the angle of the slanted face of the left end side. However, both the upper and lower mold are molds only of the portion corresponding to the left end of the pillar from a position 5 mm to the right end from the angle between the slanted face and the main plane of the pillar.

In working example 4, after performing steps in the same manner as working example 1 until the bending step of the right end portion, the bending process is performed using the cross-section molds 95 and 96 of FIG. 9(b). In this bending process, the left end portion of the cross direction of the sheet is sandwiched by the upper and lower molds with the upper and lower molds being heated to 120° C. This state was maintained for thirty seconds. Afterward, the left end portion process was performed by releasing the mold. A sample was achieved with the right end portion processed first at approximately 90°, the left end portion processed next at a position approximately 7 mm from the left end of the pillar, from this position to the right side approximately 3 mm, being parallel with the main plane, and a slanted face slanted approximately 30° from this point on the end portion side plane approximately 2.5 mm low on the car body side, with a shape connecting to the main plane.

It was confirmed that with the peeling liner peeled off, it did not sag down even when being held horizontally grasping the lower end and that it has the ability to stand maintaining the shape. The upper end of the sheet was positioned and crimped on the upper end of the pillar portion by a squeegee from the front side. After crimping the shaping sheet in order by passing the squeegee through in the downward direction as is, the shaping sheet was bent along a curvature in the vertical direction of the pillar face and maintained its shape by the adhesion of the pressure sensitive adhesive layer, continued to be secured, and was able to be easily adhered without the position being out of place in the cross direction partway through Both end portions of the pillar were covered by both end bending portions of the shaping sheet by matching the curvature, and particularly the left end is decorated and covered black to match three pillar faces (end portion side plane, slanted face, and main plane) arranged vertically, and because from the end portion of the pillar until approximately 7 mm in is covered by a rubber component, there is no need to cover with a sheet molding After peeling off the PET film, a good looking, high gloss, black appearance was achieved in the same face shape as the pillar shape. It is a little under 0.6 mm thicker than the pillar face, but this difference in height is barely recognizable with the naked eye. It was understood that the surrounding view after reflecting off the front face was clear, and the surface smoothness was high.

### Working Example 5, 6, 7, 8, and 9

The adhesive-backed decorative article according to working examples 5, 6, 7, 8, and 9 was created by creating a sheet changing the thickness of the polycarbonate sheet that configures the substrate layer of working example 1 to 0.2 mm, 0.3 mm, 0.4 mm, 0.8 mm, and 1 mm respectively, and performing processes in the same manner as working example 1. A sample was achieved that had the ability to stand, wherein the surface was smooth and both ends were bent at approximately 90°.

### Working Examples 10, 11, and 12

The adhesive-backed decorative article according to working examples 10, 11, and 12 with both ends bent in approximately 90° was created by changing the polycarbonate sheet in working example 2 to an ABS (Shin-Etsu Polymer Co., 975 BK1), a non-stretched PET (Sumitomo Bakelight Co., EPG 101WP), and a rigid PVC (Sekisui Chemical Co., AM-1000) respectively, and performing processes in the same manner as working example 2.

### Working Example 13

The adhesive-backed decorative article according to working example 13 was created by changing the front face protective layer to match the following proportion chart.

TABLE 2

| Name | Supplier | Chemical, function | Ratio (wt%) |
|---|---|---|---|
| A575 | Sumitomo Chemical | Acrylic Polyol | 56.1 |
| | Bayer Urethane | | |
| | (Hyogo, Japan) | | |
| TINUVIN | Chiba Specialty | Photostabilizer | 0.9 |
| 292 | Chemical | | |
| | (Basle, Switzerland) | | |
| TINUVIN | Chiba Specialty | Ultraviolet light | 0.9 |
| 99-2 | Chemical | absorber | |
| | (Basle, Switzerland) | | |
| Buthyl | Sankyo Chemical | Solvent | 9.3 |
| acetate | Industry | | |
| | (Tokyo, Japan) | | |
| N3300 | Sumitomo Chemical | Hexamethylene | 23.4 |
| | Bayer Urethane | diisocyanate | |
| | (Hyogo, Japan) | trimer | |
| TT-502 | (Tokyo, Japan) | Black pigment | 9.3 |
| | | sum | 100.0 |

### Comparative Example 1

A Honda genuine component 72930-TY2-A01 for decorating an automobile center pillar was used as the adhesive-backed decorative article according to comparative example 1. After injection molding an acrylic resin that has been colored black, a double sided tape with a width of 10 mm was adhered to the back face by an acrylic pressure sensitive adhesive separated in two rows in the vertical direction. The adhesive-backed decorative article according to comparative example 1 had a thickness of 2.7 mm and a weight of 85 g. It was bent according to the curvature in the vertical direction of the corresponding pillar, and construction was easily carried out by pressing to match the position after peeling off the peeling liner of the double sided tape. Even when viewed under direct sunlight, the surface appears as a transparent black with no cloudiness, and the image of a fluorescent lamp appeared smooth and clear. However, it was obviously higher than the face of the pillar before constructing, and the height difference with the adjacent glass face was noticeable.

### Comparative Example 2

A high gloss/blackout film, Toyota genuine component 75932-28010-F, was used as the adhesive-backed decorative article according to comparative example 2. This film has a polyurethane coat film formed on the front face of a black, soft PVC film of approximately 0.1 mm, and an adhesive layer by an acrylic pressure sensitive adhesive and a peeling liner are formed on the back face thereof The thickness of the film was 0.16 mm, and the weight was 10 g. Because it was thin and flexible, it is understood that it does not have the ability to stand, and sags down when being held horizontally grasping one end. It is necessary to continue to maintain the tight, tense state by holding each of both ends in the longitudinal direction so that the pressure sensitive adhesive face does not contact portions other than the adhering surface of the substrate, causing them to stick together, particularly after the peeling liner has been peeled off, making handling difficult. It was necessary to prepare the corresponding center pillar, and always pull the lower end of the film even when adhering in the downward direction by the squeegee after pressing the upper end; if this force is too strong, there are defects where the film stretches and the dimensions change, or the film becomes warped, and the direction that it sticks out in is out of place, and if this force is too weak, there is the defect of having too much film, and the film is adhered with wrinkles or air bubbles. It was necessary to have an additional operation for adhering both end portions in the film cross direction along one end portion of the pillar after adhering the plane portion in the vertical direction, and a total of three adhering operations were necessary. Even when successfully adhered, it was not smooth, and the image of a fluorescent lamp was blurry due to the orange peel-like skin of the pillar coat. In addition, it appeared as a black that lacked transparency, where cloudiness of the PVC resin was noticeable when viewed under direct sunlight.

### Comparative Examples 3 and 4

The adhesive-backed decorative article according to comparative examples 3 and 4 was created by making a sheet where the thickness of the PC sheet according to working example 1 was changed to 0.075 mm and 1.5 mm respectively, and performing processes in the same manner as working example 1. Comparative example 3 stretched and did not have the ability to stand, and in comparative example 4, it was difficult to follow the adhering surface.

### Evaluation Tests

Various evaluation tests were performed using the adhesive-backed decorative article according to the working examples, and the adhesive-backed decorative article according to the comparative examples described above (or using test pieces formed under the same conditions).

### Adhering Evaluation Test

An evaluation of the ease of adhering was performed by adhering the adhesive-backed decorative article according to working example 1, the adhesive-backed decorative article according to comparative example 1, and the adhesive-backed decorative article according to comparative example 2 to the adhering surface of a center pillar, which was the target substrate. After selecting three people as operators who were not accustomed the construction of any adhesive-backed decorative article and communicating the construction method, each person constructed each adhesive-backed decorative article five times, and the time it took and the existence of defects in appearance after construction caused by position displacement or constructing operation were evaluated.

With the adhesive-backed decorative article according to comparative example 2, a positioning jig with two pins sticking forwardly out was temporarily secured on the upper end portion of the pillar by a magnet, the pin was passed through an opening portion in a portion extending from the upper end portion of the film where it can be cut off, and the peeling liner was peeled off from the upper end portion. At this time, a phenomenon occurred twice where the film undulated, and the pressure sensitive adhesive face contacted the pillar because the film did not have the ability to stand. The opposite side was held and adhered by a squeegee from up to down while always being adhered with the pin, but because it has extensibility, the entire body stretches when the force pulling the film is too strong, and a phenomenon occurred three times where a portion stretched, the adhering direction changed, and the adhering position was off the target position by 0.5 mm or more. A phenomenon occurred three times where the adhesion was performed after weakening the pulling force to avoid stretching the film, but there was too much film and wrinkles occurred. The films wherein these defects occurred were all thrown away, and a new film was adhered after peeling off the first. Moreover, even when successfully adhered, it is necessary to also adhere along both end portions after adhering the main body portion to the adhering surface, it takes time and effort because it is necessary to perform a total of three adhering operations, and an average of 70 seconds was necessary to complete adhering.

Because the adhesive-backed decorative article according to comparative example 1 has a nonextensible main body portion, and the shape (curved shape) already corresponds to the adhering surface, it only needs an operation for peeling off the liner of the double sided tape, positioning, and adhering by pressing the adhesive-backed decorative article to the pillar, defects did not occur even once, and an average of 18 seconds was necessary to complete adhering.

The adhesive-backed decorative article according to working example 1 is adhered by peeling off the liner, positioning a lower face temporarily secured on the upper portion of the pillar with a magnet by putting it to a positioning jig of a linear wall, and adhered by a squeegee from top to bottom. Because it has the ability to stand, it is easy to handle, and because it is nonextensible, the adhering position is not off target. Furthermore, adhering is simple because it is not necessary to also adhere both end portions, defects did not occur even once, and an average of 18 seconds was necessary to complete adhering. From the above, it is understood that adhering is simple in the adhesive-backed decorative article according to working example 1 when compared to comparative example 2.

TABLE 3

| | Construction | Defect | |
|---|---|---|---|
| | Time *1 | Ratio *2 | Defects |
| Working Example 1 | 18 | 0/15 | — |
| Comparative Example 1 | 18 | 0/15 | — |
| Comparative Example 2 | 70 | 8/15 | Sticking: 2 |
| | | | Off position: 3 |
| | | | Wrinkles: 3 |
| | (sec) | (No.) | |

*1 The average amount of time it took to construct one. When position displacement or defects in appearance due to operation occurred, the time it took to peel off and reconstruct was also added.
*2 Displacement of 0.5 mm or more, or appearance defects due to improper operation
Number of defect occurrences within 15 times of initial construction

### Evaluation of Thickness After Adhering, Effects of Weight

The adhesive-backed decorative article according to working example 1, the adhesive-backed decorative article according to comparative example 1, and the adhesive-backed decorative article according to comparative example 2 were adhered to the pillar, and the thickness appearance and increase in vehicle weight was measured. Because the main body of the adhesive-backed decorative article according to working example 1 is thin with a total thickness of approximately 0.6 mm, the change in pillar height due to the adhesion could not be recognized by visual observation. Moreover, the increase in vehicle weight when four were constructed in the front, back, left, and right, with one at each door, was held at 96 g.

Because the main body of the adhesive-backed decorative article according to comparative example 1 is thick with a total thickness of approximately 2.9 mm, it can be recognized by visual observation that the pillar is clearly higher due to the adhesion. It is preferable for the center pillar to not stick out from the glass face as much as possible, under design requests seeking for unity with the front and back glass windows to decorate the center pillar in black, and design is largely lost due to this fact. Furthermore, there is a worry of a large negative effect on fuel efficiency and the like because the increase in vehicle weight when constructing one on each of the four left and right doors is a 340 g. The adhesive-backed decorative article according to comparative example 2 is thin with 0.15 mm, thick with 40 g/vehicle, and excels in appearance and weight.

TABLE 4

| | | | Increase |
|---|---|---|---|
| | | | in Weight |
| | Thickness | Appearance *1 | (1/vehicle *2) |
| Working | 0.61 | Cannot recognize | 24/96 |
| Example 1 | | a change | |
| Comparative | 2.9 | Higher | 85/340 |
| Example 1 | | | |
| Comparative | 0.15 | Cannot recognize | 10/40 |
| Example 2 | | a change | |
| | (mm) | | (g) |

*1 Can it be seen that the height of the center pillar with respect to the glass face has changed before and after construction?
*2 Four on the center pillars on the front and back, left and right doors

Furthermore, the adhesive-backed decorative article according to working example 1, the adhesive-backed decorative article according to comparative example 1, and the adhesive-backed decorative article according to comparative example 2 were adhered to a coat plate with a sharpness of 0.2 wherein an outer panel coat material was spray coated on a steel plate that is flat similar to that used in an automobile and baked. Afterward, the sharpness before and after adhering to the adhering surface was measured using a portable total sharpness/glossiness type PGD-IV (Manufactured by Japan Color Research Institute). The adhesive-backed decorative article according to working example 1 had a surface sharpness of 0.9 before and after adhering. The adhesive-backed decorative article according to comparative example 1 had a surface sharpness of 0.8 before and after adhering. In other words, it is understood that the adhesive-backed decorative article according to working example 1 and comparative example 1 has high surface smoothness and is substantially the same before and after adhering. Meanwhile, the adhesive-backed decorative article according to comparative example 2 had a sharpness of 0.7 before adhering, and a sharpness of 0.2 after adhering. In other words, the unevenness of the adhering surface underneath had an effect after adhering. By this, it is understood that the sharpness of the adhesive-backed decorative article according to comparative example 2 is not substantially the same before and after adhering, and after adhering to an adhering surface with low smoothness, it has a product quality appearance with low smoothness. Smoothness is increasingly lost from the horizontal face due to the sagging of a coat particularly in a vertical direction such as a pillar in a coat face of a vehicle which is the substrate, and it often becomes a so-called orange peel state. In this manner, it is a large advantage that the adhesive-backed decorative article according to working example 1 is not affected by the quality of the adhering surface.

TABLE 5

| | Before | After |
|---|---|---|
| | Adhering | Adhering * |
| Working Example 1 | 0.9 | 0.9 |
| Comparative Example 1 | 0.8 | 0.8 |
| Comparative Example 2 | 0.7 | 0.2 |

* After adhering to a coat plate of 0.2 sharpness

### Bending Rigidity

An evaluation of the bending rigidity of the adhesive-backed decorative article according to working examples 1, 3, 4, 5, 6, 7, and 8, the adhesive-backed decorative article according to comparative example 1, and the adhesive-backed decorative article according to comparative example 2 was performed. This test was performed by forming a test piece with the same materials and same thickness as the main body portion that configures each adhesive-backed decorative article, and using this test piece. This test was performed in accordance with the JIS L-1096 bending repulsion A method using a Gurley flexibility test machine. The maximum load was recorded after 40 mm of the width and 4.5 inches (114 mm) of the length was cut off each of the left and right ends in the cross direction of each sample, one end was secured in a vertical direction on the test machine, reaches a bar that passes through a determined position shorter than the length of the sample that protrudes, warps, and finally makes it through. By averaging the data of the left and right ends, the value of the bending rigidity with an adhesive-backed decorative article with a width of 80 mm was calculated.

Because the adhesive-backed decorative article according to comparative example 1 has too large of a bending rigidity when compared with the adhesive-backed decorative article according to the working examples, it is understood that constructing while bending to match the shape of the substrate is difficult. Furthermore, because the adhesive-backed decorative article according to comparative example 2 is too small compared with the adhesive-backed decorative article according to the working examples, it is understood that it does not have the ability to stand and is hard to handle. The adhesive-backed decorative article according to the working examples excels in being easy to handle due to the ability to stand, and bending rigidity because it has appropriate bending rigidity.

TABLE 6

| | Bending | Ability to | Bending | | |
|---|---|---|---|---|---|
| | Rigidity *1 | Stand *2 | Rigidity *3 | Bent Shape of End portion | Thickness |
| Working Example 1 | 0.38 | Yes | Simple | Left end 90° Right end 90° | 0.61 |
| Working Example 3 | 0.47 | Yes | Simple | Left end 90° Right end 180° | 0.58 |
| Working Example 4 | 0.44 | Yes | Simple | Left end [symbol] Right end 90° | 0.61 |
| Working Example 5 | 0.11 | Yes | Simple | Left end 90° Right end 90° | 0.31 |
| Working Example 6 | 0.13 | Yes | Simple | Left end 90° Right end 90° | 0.41 |
| Working Example 7 | 0.19 | Yes | Simple | Left end 90° Right end 90° | 0.51 |
| Working Example 8 | 1.13 | Yes | Simple | Left end 90° Right end 90° | 0.91 |
| Working Example 9 | 1.99 | Yes | Simple | Left end 90° Right end 90° | 1.11 |
| Working Example 10 | 0.32 | Yes | Simple | Left end 90° Right end 90° | 0.61 |
| Working Example 11 | 0.41 | Yes | Simple | Left end 90° Right end 90° | 0.61 |
| Working Example 12 | 0.43 | Yes | Simple | Left end 90° Right end 90° | 0.61 |
| Comparative Example 1 | 9.05 | Yes | Difficult | Left end 90° Right end 90° | 2.9 |
| Comparative Example 2 | 0.005 | None | Simple | No bending on both sides | 0.15 |
| Comparative Example 3 | 0.01 | None | Simple | Left end 90° Right end 90° | 0.185 |
| Comparative Example 4 | 4.73 | Yes | Difficult | Left end 90° Right end 90° | 1.61 |
| | (N) | | | | (mm) |

*1 As an adhesive-backed decorative article with a bending shape with a width of 80 mm on both ends
*2 Whether or not it can be held horizontally while grasping one end in the longitudinal direction with the PET and peeling liner peeled off
*3 Can the state straight with the bend along the curvature of the pillar in the longitudinal direction be easily deformed with the force of one hand

### Tensile Elongation Strength

An evaluation of the tensile elongation strength of the adhesive-backed decorative article according to working examples 1, 5, 6, 7, and 8, the adhesive-backed decorative article according to comparative example 1, and the adhesive-backed decorative article according to comparative example 2 was performed. This test cut the sample not including the PET or peeling liner to a 10 mm width, grasped it using a tensile test machine, and calculated the load while extended at 2% when pulled at intervals of 50 mm, at a pulling speed of 300 mm/min. Three case studies were performed based on this value.
Assumed Limit 1; Force necessary to extend an adhesive-backed decorative article with a width of 80 mm 2% (8 times the actual value by width conversion)
Assumed Limit 2; Force necessary to extend an adhesive-backed decorative article with a width of 80 mm 1% (0.5 times the assumed limit 1 because low elongation tensile load curve is substantially a straight line)
Assumed Limit 3; Force necessary to extend half of one side of an adhesive-backed decorative article with a width of 80 mm 1% (0.5 times the value of assumed limit 2 by width conversion) This assumes that the adhesive-backed decorative article is pulled in a direction leaning to either the left or right during adhesion.

Meanwhile, the standard load applied by a hand during the adhering operation is 20 N, and the maximum is 40 N. When comparing this value with the assumed limit value, the value of assumed limit 2 of comparative example 2 is the same as the manual work load maximum value, this shows a possibility of stretching 1% when conditions are met during the adhering operation. The value of assumed limit 3 is the same as the manual work load standard value, and shows that stretching 1% to one side during a general adhering operation can often occur. This is congruent with the fact that position displacement occurs in the adhering evaluation described above.

The adhesive-backed decorative article according to working examples 1, 5, 6, 7, and 8, and the adhesive-backed decorative article according to comparative example 1 show a value that exceeds the manual work load maximum value in all the assumed cases, which shows that the possibility of stretching and causing position displacement during the adhering operation is low.

TABLE 7

| | | Case Study | | |
|---|---|---|---|---|
| | Actual Value | Assumed | Assumed | Assumed |
| | Tensile When | Limit 1 *1 | Limit 2 *2 | Limit 3 *3 |
| | Strength | Entire | Entire | Half |
| | Extended 2% | Width/2% | Width/1% | Width/1% |
| Working | 109 | 874 | 437 | 218 |
| Example 1 | | | | |
| Working | 44 | 352 | 176 | 88 |
| Example 5 | | | | |
| Working | 66 | 528 | 264 | 132 |
| Example 6 | | | | |
| Working | 87 | 696 | 348 | 174 |
| Example 7 | | | | |
| Working | 175 | 1400 | 700 | 350 |
| Example 8 | | | | |
| Comparative | 654 | 5232 | 2616 | 1308 |
| Example 1 | | | | |
| Comparative | 10 | 80 | 40 | 20 |
| Example 2 | | | | |
| | (N/10 mm) | (N/80 mm) | (N/80 mm) | (N/40 mm) |

*1 Force necessary to stretch the entire width 2% with an adhesive-backed decorative article with a width of 80 mm
*2 Force necessary to stretch the entire width 1% with an adhesive-backed decorative article with a width of 80 mm
*3 Force necessary to locally stretch only half of the width 1% with an adhesive-backed decorative article with a width of 80 mm

### Pencil Hardness Test

The adhesive-backed decorative article according to working example 1, the adhesive-backed decorative article according to comparative example 1, and the adhesive-backed decorative article according to comparative example 2 were adhered to a coat steel plate with the sharpnesses measured above, and following JIS K5600-5-4, scratch marks were checked after scratching five times with a load of 750 g, at an angle of 45°, at a speed of 600 mm/min, for a distance of 10 mm with a pencil at various center hardnesses. The coat steel plate itself has hardness of HB or greater. The adhesive-backed decorative article according to comparative example 2 is at a level where there are clear scratches even with a hardness of 6B, and it is assumed that it will be scratched easily in practical use by a human fingernail. The adhesive-backed decorative article according to working example 1 and the adhesive-backed decorative article according to comparative example 1 show high pencil hardness, and show scratch resistance where they will not be scratched easily in practical use by a human fingernail.

TABLE 8

| | Pencil |
|---|---|
| | Hardness |
| Working Example 1 | B |
| Comparative Example 1 | H |
| Comparative Example 2 | <6B |

### Car Wash Scratch Test

The gloss at 60° of the surface of a sample with the adhesive-backed decorative article according to working example 1, the adhesive-backed decorative article according to comparative example 1, and the adhesive-backed decorative article according to comparative example 2 adhered to a coat steel plate with the sharpnesses measured above, were measured with a gloss meter. After dirt was applied on the surface and dried, a car wash was performed with a vehicle wash machine, and the surface was scratched with a brush. The dirt was then washed off with water directly after repeating the above three times, the gloss was measured again at 60° after ten days, and the retention rate was calculated. Appearance by visual observation was also recorded. The entire surface had scratches and the reflection level of the surface had clearly fallen with comparative example 1. It is assumed that scratches will occur easily in practical use being scraped in a car wash or the like. No scratches could be confirmed by visual observation with the adhesive-backed decorative article according to working example 1 and the adhesive-backed decorative article according to comparative example 2; this shows that the gloss is also nearly the same as before the test, and it is also shown that scratches will not occur due to a car wash or the like in practical use.

TABLE 9

| | 60° Gloss | | | |
|---|---|---|---|---|
| | | 10 Days | Retention | Visual Observation |
| | Original | After Test | Rate (%) | 10 Days After Test |
| Working | 89.8 | 87.6 | 98 | No scratches |
| Example 1 | | | | |
| Comparative | 88.0 | 55.2 | 63 | Scratches along |
| Example 1 | | | | entire surface |
| Comparative | 92.2 | 91.5 | 99 | No scratches |
| Example 2 | | | | |

### Haze Evaluation

The black haze was visually checked under a fluorescent lamp inside and under direct sunlight outside for the adhesive-backed decorative article according to working example 1, the adhesive-backed decorative article according to comparative example 1, and the adhesive-backed decorative article according to comparative example 2 constructed on a pillar in the adhering evaluation described above. Comparative example 2, which is pigment colored on soft PVC, could not be recognized under a weak fluorescent lamp, but under strong direct sunlight, cloudiness can be clearly seen. Cloudiness could not be observed under either with working example 1 and comparative example 1. It demonstrated a preferable transparent black called piano black.

TABLE 10

| | Haze | |
|---|---|---|
| | Fluorescent Lamp | Direct Sunlight |
| Working Example 1 | No cloudiness | No cloudiness |
| Comparative Example 1 | No cloudiness | No cloudiness |
| Comparative Example 2 | No cloudiness | Cloudiness |

### 90° Peeling Strength

The adhesive-backed decorative article according to working examples 1, 5, 6, 7, and 8, and the adhesive-backed decorative article according to comparative example 1 were cut into a 25 mm width, adhered to a coat plate with a Kansai Paint Co. AMILAC coat material applied and baked, and the average load was measured when pulled and peeled for one hour in a 90° direction at 300 mm/min. While there are differences depending on the thickness, the adhesive-backed decorative article according to all the working examples showed a higher peeling strength than comparative example 2 which has actual results in the market, and it is thought that sufficient adhesion for the market has been achieved.

TABLE 11

| | 90° Peeling | |
|---|---|---|
| | Strength One | |
| | Hour after | Supplementary |
| | Adhering | Thickness |
| Working Example 1 | 15.3 | 0.61 |
| Working Example 5 | 20.4 | 0.31 |
| Working Example 6 | 19.3 | 0.41 |
| Working Example 7 | 20.6 | 0.51 |
| Working Example 8 | 13.2 | 0.91 |
| Comparative Example 2 | 12.4 | 0.15 |
| | (N/25 mm) | (mm) |

### 90° Workability

A sample was created by bending the sheet of working examples 1, 2, 5, 6, 7, 8, and comparative examples 6 and 8 using the 90° bend mold with conditions of the upper mold temperature being 150° C., 120° C., and 23° C. The working example samples with the upper mold heated from 120° C. or 150° C. with PC as the substrate layer and PUR as the front face protective layer were all able to be bent as planned at nearly 90° in the range of “main body thickness” and “peeling liner thickness” in table 11. With comparative example 6, PMMA of the protective layer caused cracks during the bending process, and when a sheet with the same configuration as working example 2 was processed with an upper mold temperature of 23° C., the angle was an angle of 145°, much wider than planned, and a quality product could not be achieved.

TABLE 12

| | Main Body | Peeling Liner | | Upper Mold | |
|---|---|---|---|---|---|
| | Thickness | Thickness | Protective | Temperature | 90° Bending |
| | (mm) | (mm) | Layer | (°C) | Workability |
| Working Example 1 | 0.61 | 0.025 | PUR | 150 | Approximately 90° |
| Working Example 2 | 0.61 | 0.14 | PUR | 120 | Approximately 90° |
| Working Example 5 | 0.31 | 0.025 | PUR | 150 | Approximately 90° |
| Working Example 6 | 0.41 | 0.025 | PUR | 150 | Approximately 90° |
| Working Example 7 | 0.51 | 0.025 | PUR | 150 | Approximately 90° |
| Working Example 8 | 0.91 | 0.025 | PUR | 150 | Approximately 90° |

### 80° C. Heat Resistance

A sample for adhering to a pillar was created in the same manner as working example 1 using the sheet of working examples 2, 10, 11, and 12 using the 90° bend mold with conditions of the upper mold temperature being 120° C., and appearance was checked after peeling off the peeling liner and undergoing a heat resistance test for 24 hours at 80° C. In working example 13, cracks occurred on the surface. Meanwhile, it was confirmed that no cracks occurred on the adhesive-backed decorative article surface after the heat resistance test in all of working examples 2, 10, 11, and 12. Moreover, warping of the substrate did not occur in the heat resistance test of 80° with working examples 2 and 13. In all of working examples 10, 11, and 12, the entire sheet was largely warped. Note that the rupture elongation was measured in a test by cutting a test piece with a width of 10 mm, grasping at a 50 mm interval, and pulling at a speed of 300 mm/min.

TABLE 13

| | PUR Rupture | Substrate Layer | Substrate Layer | 80° C. |
|---|---|---|---|---|
| | Elongation (%) | Resin | Tg (°C) | Heat Resistance |
| Working Example 2 | 120 | PC | 150 | No abnormalities |
| Working Example 10 | 120 | ABS | 80-125 | Warp deformations |
| | | | | along entire surface |
| Working Example 11 | 120 | Nonextensible | 65 | Warp deformations |
| | | PET | | along entire surface |
| Working Example 12 | 120 | Rigid PVC | 87 | Warp deformations |
| | | | | along entire surface |
| Working Example 13 | 15 | PC | 150 | Cracks occurred on |
| | | | | adhesive-backed |
| | | | | decorative article |
| | | | | surface |

### DESCRIPTION OF THE REFERENCE NUMERALS

Adhesive-backed decorative article,

2 Main body portion,

2a Front face,

2b Back face,

3 End portion,

3a Front face,

4 Adhesive layer (adhesive portion),

6, 8 Substrate layer,

7, 9 Front face protective layer,

50 Substrate,

50a Adhering surface,

100 Sheet-shaped member.

1. An adhesive-backed decorative article adhered on an adhering surface of a substrate, comprising:
a main body portion having a front face to be a design face and a back face,
an end portion extending from one side of the main body portion, having a front face forming a prescribed angle relative to the front face of the main body portion, and
an adhesive portion disposed on at least one portion of the back face side of the main body portion, wherein
the main body portion is deformable due to the shape of the adhering surface, and it can also be adhered and secured to the adhering surface via the adhesive portion without substantially stretching during adhering.

2-4. (canceled)

5. The adhesive-backed decorative article according to claim 1, wherein the main body portion includes a resin layer with a glass transition temperature of 130° C. or greater.

6. The adhesive-backed decorative article according to claim 1, wherein the main body portion includes a polycarbonate layer.

7. The adhesive-backed decorative article according to claim 1, wherein the main body portion includes a polyurethane layer as a front face protective layer.

8. The adhesive-backed decorative article according to claim 7, wherein the front face protective layer has a rupture elongation of 100% or greater in a temperature of 80° C. or greater.

9. The adhesive-backed decorative article according to claim 1, wherein the main body portion and the end portion use a sheet-shaped member with one adhesive portion attached, and the end portion is formed by banding an end portion of the sheet-shaped member.

10. The adhesive-backed decorative article according to claim 1, wherein the adhesive portion is laminated on the entire back face of the main body portion.

11. The adhesive-backed decorative article according to claim 1, wherein the end portion has a shape covering at least a portion of the side face of an end edge of the adhering surface along the side face, when adhering to the adhering surface.

12. The adhesive-backed decorative article according to claim 1, wherein the end portion has a surface forming an angle of approximately 90° relative to the front face of the main body portion.

13. The adhesive-backed decorative article according to claim 1, comprising a second end portion with a surface forming a fixed angle relative to the front face of the main body portion, extending from a second side opposing the one side.

14. The adhesive-backed decorative article according to claim 13, comprising a third end portion with an angle different from the second end portion, connected to the second end portion.

15. The adhesive-backed decorative article according to claim 1, wherein the third end portion has a surface forming an angle of approximately 0° relative to the front face of the main body portion.

16. The adhesive-backed decorative article according to claim 1, wherein the adhesive portion has a microstructured surface, and
a groove of a prescribed pattern formed on the microstructured surface has a prescribed volume of at least 1×10 μm, in a circular region with a radius of 500 μm set in any location corresponding to the pattern.

17. (canceled)

18. The adhesive-backed decorative article according to claim 1, wherein the main body portion extends along a first direction, and can be curved in the first direction.

19. The adhesive-backed decorative article according to claim 1, wherein the main body portion has a belt shape, and the end portion extends from one end extending in the longitudinal direction.

20-22. (canceled)

23. A method for manufacturing the adhesive-backed decorative article according to claim 1, adhered to an adhering surface of a substrate, comprising: a step for preparing a sheet-shaped member with an adhesive attached having a front face that will be a design face,
and a bending step for bending an end portion of the sheet-shaped member, and forming a fixed angle relative to a surface.

24. The method for manufacturing an adhesive-backed decorative article according to claim 23, wherein the bending step comprises:
a step for preparing a pair of molds,
a step for securing the sheet-shaped member to one mold,
and a step for forming a fixed angle relative to the sheet-shaped member by relatively moving at least one of the one mold or the other mold.

25. The method for manufacturing an adhesive-backed decorative article according to claim 23, wherein the bending step is performed at 80° C. or greater.

26. An adhering method for the adhesive-backed decorative article according to claim 1, with an adhesive-backed decorative article adhered to an adhering surface of a substrate, comprising:
a step for preparing the adhesive-backed decorative article,
and a step for deforming the main body portion based on the shape of the adhering surface, and adhering and securing the main body portion to the adhering surface via the adhesive portion without substantially stretching.

27. The adhering method of an adhesive-backed decorative article according to claim 26, wherein the step for securing includes a step for determining a location of the end portion and an end portion of the adhering surface.
